(19) United States
(12) Patent Application Publication
(10) Pub. No.: US 2009/0213086 A1
(43) Pub. Date: Aug. 27, 2009

(54) TOUCH SCREEN DEVICE AND OPERATING METHOD THEREOF

(76) Inventors: Ji Suk Chae, Seoul City (KR); Ho Joo Park, Seoul City (KR); Young Ho Ham, Yongin City (KR); Kyung Hee Yoo, Seoul City (KR); Ji Ae Kim, Seoul City (KR); Yu Mi Kim, Seongnam City (KR); Sang Hyun Shin, Seoul City (KR); Seung Jun Bae, Busan City (KR); Yoon Hee Koo, Sacheon City (KR); Seong Cheol Kang, Osan City (KR); Jun Hee Kim, Seongnam City (KR); Byeong Hui Jeon, Geumsan-gun (KR)

Correspondence Address: KED & ASSOCIATES, LLP, P.O. Box 221200, Chantilly, VA, 20153-1200, US

(21) Appl. No.: 12/368,379

(22) Filed: Feb. 10, 2009

Related U.S. Application Data
(63) Continuation-in-part of application No. 11/646,613, filed on Dec. 28, 2006.

(30) Foreign Application Priority Data
Apr. 19, 2006 (KR) 10-2006-0035443
Apr. 19, 2006 (KR) 10-2006-0046716
Apr. 24, 2006 (KR) 10-2006-0046696
May 24, 2006 (KR) 10-2006-0046697
May 24, 2006 (KR) 10-2006-0046698
May 24, 2006 (KR) 10-2006-0046699
May 24, 2006 (KR) 10-2006-0046710
May 24, 2006 (KR) 10-2006-0046715
May 24, 2006 (KR) 10-2006-0046717

(51) Int. Cl. G06F 3/041; G06F 3/01

(52) U.S. Cl. 345/173; 715/702

(57) ABSTRACT

A touch screen device and an operating method thereof are provided. The touch screen device is operated by touching a touch screen and moving a touch while the touch is maintained on the screen. A detector detects a touch point and a moving trajectory, and a controller selects a user command based on the detected touch point and moving trajectory. Then, when the user releases the touch, the controller executes the user command. User commands are classified and stored in a storage device and then executed by the controller based on operation modes associated with the device. A variety of user commands may be executed even though not all the menus are not displayed on the screen at once. Further, a user may cancel an erroneously entered user command quickly and easily.

This application is a continuation-in-part of U.S. patent application Ser. No. 11/646,613, filed on Dec. 28, 2006, which claims priority to Korean Application No. 10-2006-0046717, filed in Korea on May 24, 2006; Ser. No. 11/646,597, filed on Dec. 28, 2006, which claims priority to Korean Application No. 10-2006-0046698, filed in Korea on May 24, 2006; Ser. No. 11/646,598 filed on Dec. 28, 2006, which claims priority to Korean Application Nos. 10-2006-0046697 and 10-2006-0046699, each filed in Korea on May 24, 2006; Ser. No. 11/646,604, filed on Dec. 28, 2006, which claims priority to Korean Application Nos. 10-2006-0035443 and 10-2006-0046716, filed in Korea on Apr. 19, 2006 and May 24, 2006 respectively; Ser. No. 11/646,586, filed on Dec. 28, 2006, which claims priority to Korean Application No. 10-2006-0046696, filed in Korea on Apr. 24, 2006; Ser. No. 11/646,587, filed on Dec. 28, 2006, which claims priority to Korean Application No. 10-2006-0046710, filed in Korea on May 24, 2006; and Ser. No. 11/646,585 filed Dec. 28, 2006, which claims priority to Korean Application No. 10-2006-0046715, filed in Korea on May 24, 2006. All of these documents are hereby incorporated by reference.

### BACKGROUND

1. Field

A touch screen device and an operating method thereof are disclosed herein.

2. Background

Portable information terminals such as, for example, personal digital assistants (PDAs), portable multimedia players (PMPs), MP3 players, cellular phones, notebook computers and the like have become smaller in size. These portable information terminals can typically process a variety of multimedia information, such as music, games, photographs, and videos. As these terminals become smaller, touch screen methods may be employed in place of conventional key button input methods so that the touch screen device can function as both an information display unit and an input unit. Such touch screen methods allow users to more easily upload/download, select and input information and interface with other electronic devices to access and execute, for example, MP3 files, video files, and other relevant information such as title and singer information included as tag information in MP3 files and/or video files stored in the portable device.

Selection and playback of these types of files stored in the portable device may be done by manipulating a particular point on a screen of the device to select one or more files. For example, if a user's finger or other such object comes into contact with a specific point displayed on the screen, a coordinate of the contacted point may be obtained, and a specific process corresponding to a menu of the selected coordinate may be executed.

However, to allow for selection and execution of a corresponding menu in a portable information terminal equipped with a touch screen, all the available menus may be displayed so that the menus may be viewed and directly touched. This complicates the screen configuration, and drives the need for a larger screen size on the reduced size portable information terminal and more efficient manipulation of menus and selection methods.

### BRIEF DESCRIPTION OF THE DRAWINGS

Embodiments will be described in detail with reference to the following drawings in which like reference numerals refer to like elements, and wherein:

FIGS. 1 and 2 are block diagrams of a touch screen device, in accordance with embodiments as broadly described herein;

FIG. 3 is a flowchart of a method of operating the touch screen device shown in FIGS. 1 and 2, in accordance with an embodiment as broadly described herein;

FIGS. 4A-4D illustrate operation of the touch screen device shown in FIGS. 1 and 2 in a playback mode, in accordance with an embodiment as broadly described herein;

FIGS. 5A and 5B illustrate operation of the touch screen device shown in FIGS. 1 and 2 in a menu selection mode, in accordance with an embodiment as broadly described herein;

FIG. 6 is a block diagram of a touch screen device, in accordance with an embodiment as broadly described herein;

FIG. 7 is a flowchart of a method of operating a touch screen device, in accordance with an embodiment as broadly described herein;

FIGS. 8A-8C are exemplary views illustrating operations of a touch screen device, in accordance with an embodiment as broadly described herein;

FIG. 9 is a flowchart illustrating a method of operating a touch screen device in accordance with an embodiment as broadly described herein;

FIGS. 10A-10D are exemplary views illustrating operations of a touch screen device in accordance with an embodiment as broadly described herein;

FIG. 11 is an exemplary view illustrating operations of a touch screen device in accordance with an embodiment as broadly described herein;

FIG. 12 is a block diagram of a touch screen device, in accordance with an embodiment as broadly described herein;

FIG. 13 is a flowchart of a method of skipping files, in accordance with an embodiment as broadly described herein;

FIG. 14 is a flowchart of a method of scrolling a file list, in accordance with an embodiment as broadly described herein;

FIGS. 15A-15B illustrate a file skipping operation, in accordance with an embodiment as broadly described herein;

FIGS. 16A-16C illustrate a file scrolling operation, in accordance with an embodiment as broadly described herein;

FIGS. 17-18 are block diagrams of a touch screen device, in accordance with an embodiment as broadly described herein;

FIG. 19 is an exemplary illustration of menu bars displayed on a touch screen device, in accordance with an embodiment as broadly described herein;

FIG. 20 is a flowchart of a method of displaying and selecting menus on a touch screen device, in accordance with an embodiment as broadly described herein;

FIGS. 21A-21F are exemplary illustrations of operation of a touch screen device, in accordance with an embodiment as broadly described herein;

FIG. 22 is a block diagram of a touch screen device in accordance with an embodiment as broadly described herein;

FIGS. 23A-23D are exemplary views showing execution menus displayed on a touch screen device, in accordance with an embodiment as broadly described herein;

FIGS. 24A-24B are exemplary views showing execution menus displayed, in accordance with an embodiment as broadly described herein;

FIG. 25 is a flow chart of a method of displaying images on a touch screen device, in accordance with an embodiment as broadly described herein;

FIG. 26-27 are block diagrams of a touch screen device, in accordance with embodiments as broadly described herein;

FIG. 28 is a flowchart of a method of operating a touch screen device, in accordance with an embodiment as broadly described herein;

FIG. 29A is an exemplary view showing a trace image displayed on the touch screen device, in accordance with an embodiment as broadly described herein;

FIG. 29B is an exemplary view showing an icon image displayed on the touch screen device, in accordance with an embodiment as broadly described herein;

FIGS. 29C-29D are exemplary views showing text images displayed on the touch screen device, in accordance with an embodiment as broadly described herein;

FIGS. 30A-30C are exemplary views showing an embodiment as broadly described herein operated in a playback mode of an exemplary MP3 player;

FIGS. 31-32 are block diagrams of a touch screen device, in accordance with an embodiment as broadly described herein;

FIG. 33A-33B are perspective views of exemplary MP3 players utilizing a touch screen device, according to embodiments as broadly described herein;

FIG. 34 is a flowchart of an operating method, in accordance with an embodiment as broadly described herein; and

FIGS. 35A-35B are exemplary views in which a holding signal is input to a touch screen device, in accordance with an embodiment as broadly described herein.

### DETAILED DESCRIPTION

The touch screen device according to embodiments as broadly described herein may be applied to all kinds of digital equipment to which a touch screen device may be adapted, such as, for example, an MP3 player, a portable media player, a PDA, a portable terminal, a navigation system, or a notebook computer. Moreover, the touch screen device according to embodiments as broadly described herein may be used with electronic books, newspapers, magazines, etc., and different types of portable devices, for example, handsets, MP3 players, notebook computers, etc., audio applications, navigation applications, televisions, monitors, or other types of devices using a display, either monochrome or color. Simply for ease of illustration and discussion, the embodiments as broadly described herein will be discussed with respect to an MP3 player by way of example. It is noted that touch may include any type of direct or indirect touch or contact, using, for example, a finger, a stylus, or other such touching or pointing device.

As shown in FIG. 1, a touch screen device in accordance with an embodiment as broadly described herein may include a screen 10 which allows information to be input and displayed. The screen 10 may include a display 14 which may display a variety of menu related information such as, for example, icons, data, and the like thereon. The screen 10 may also include a touch panel or detector 12 for detecting a touching action related to, for example, menu or data selection displayed on the display 14. When a user touches, or touches and moves (hereinafter, referred to as ‘drags’), menus or data with a touching implement 60 such as, for example, a finger, a stylus pen, or the like, to select the menus or data displayed on the screen 10, the detector 12 may detect the touching or dragging action on the screen 10.

The display 14 may be any type of general screen display device, including, but not limited to, display devices such as, for example, a liquid crystal display (LCD), plasma display panel (PDP), light emitting diode (LED) or organic light emitting diode (OLED). The detector 12 may be a thin layer provided on a front surface of the display 14, and may employ infrared rays, a resistive method, or a capacitive method.

In the case of a resistive touch screen, such a resistive touch screen may include two layers coated with resistive materials positioned at a constant interval, with electric currents supplied to both layers. If pressure is applied to one of the layers, causing that layer to come into contact with the other layer, an amount of electric current flowing along the layers is changed at the contact point, and a touched point is thus detected based on the change in electric current. In contrast, a capacitive touch screen may include a glass layer with both surfaces coated with conductive material. Electric voltage is applied to edges of the glass, causing high frequencies to flow along the surface of the touch screen. A high frequency waveform is distorted when pressure is applied to the surface of the touch screen. Thus, a touched point is detected by a change in the waveform.

The screen 10 shown in FIG. 1 may be connected to a controller 20. The controller 20 may access a user command corresponding to a selected menu as detected by the detector 12, or data, such as additional information or messages, from a storage device 30, and cause the command or data to be displayed on the screen 10. The controller 20 may also control the overall operation of the digital equipment in which it is installed. The controller 20 may operate the digital equipment according to the detection results of the detector 12.

The controller 20 may be connected to the storage device 30. The storage device 30 may store user commands defined in accordance with a particular touched point or a particular drag trajectory (hereinafter, referred to as a ‘moving trajectory’) to be executed by the controller 20. The storage device 30 may be divided based on modes of operation, and user commands may be stored corresponding to the touched points and moving trajectories. The touched points and the moving trajectories corresponding to the user commands may be defined by a user. That is, the user may assign or change touched points, moving trajectories, and released points corresponding to the respective user commands based on personal preference.

The controller 20 may also control an access command corresponding to a menu to be selected based on the detection results of the detector 12. Further, the controller 20 may also control the overall operation of the digital equipment with which the particular touch screen is provided, and may operate the digital equipment according to the detection results of the detector 12.

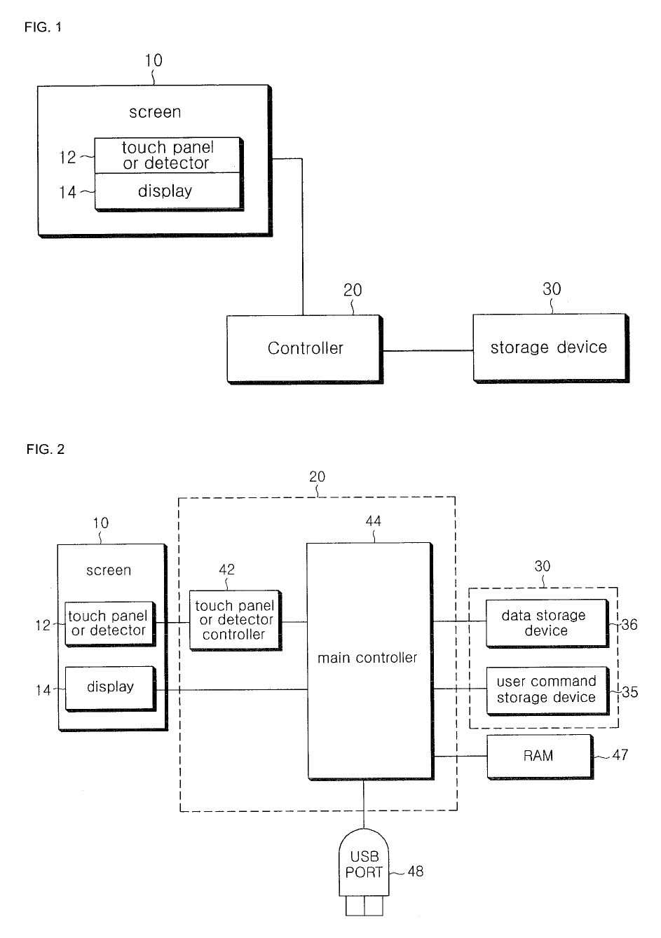

The touch panel or detector 12 shown in FIG. 1 may be connected to a touch panel or detector controller 42 which may convert a touch detected on the touch panel or detector 12 into a corresponding signal, as shown in FIG. 2. The touch panel or detector controller 42 may allow a change in an amount of electric current or high frequency waveform corresponding to an input position on the touch panel or detector 12 to be converted into a digital signal. The display 14 and the touch panel or detector controller 42 may be connected to a main controller 44 and each may operate under the control of the main controller 44. The main controller 44 may be configured such that a touch type can be detected by extracting a touch point and moving trajectory from digital signals input from the touch panel or detector controller 42, as described above.

A user command storage device 35 for storing information related to a user command based on a particular touch type may be connected to the main controller 44. The user command information stored in the user command storage device 35 may be classified by the operation mode and contain a user command for equipment corresponding to a specific touch type. Description images corresponding to the commands may also be stored in the user command storage device 35. The description images may be displayed to inform the user of the particular user command currently being executed.

Examples of touch types and corresponding user commands for a particular operation mode are shown in Table 1.

TABLE 1
<Play List Choice Mode>

| | Speed | | | |
|---|---|---|---|---|
| | Under | | | |
| Type | 1 S/Cm | 1-2 S/Cm | 2-4 S/Cm | Up 4 S/Cm |
| Transfer from | Transfer play | Transfer play | Transfer play | Transfer play |
| the upper end | list down- | list down- | list down- | list down- |
| on the right | ward at a | ward at a | ward at a | ward at a |
| side to the | speed of 1 | speed of 2 | speed of 4 | speed of 5 |
| lower end | S/Cm | S/Cm | S/Cm | S/Cm |
| Transfer from | Transfer play | Transfer play | Transfer play | Transfer play |
| the lower end | list upward | list upward | list upward | list upward |
| on the right | at a | at a | at a | at a |
| side to the | speed of 1 | speed of 2 | speed of 4 | speed of 5 |
| upper end | S/Cm | S/Cm | S/Cm | S/Cm |

| | |
|---|---|
| Transfer from | Skip play list within touch area |
| the upper end | |
| on the left | |
| side to the | |
| lower end on | |
| the right side | |
| Transfer from | Delete play list within touch area |
| the upper end | |
| on the right | |
| side to the | |
| lower end on | |
| the left side | |

A data storage device 36 for storing a variety of information, such as, for example, files, and in the example of a media player, MP3 files and the like, may be connected to the main controller 44. In certain embodiments, a NAND memory capable of rapidly and easily storing and reading out a large amount of information may be used as the data storage device 36. A portion of the data storage device 36 may be used as the user command storage device 35. However, a separate user command storage device 35 may be provided. For example, use of a user command storage device constructed of, for example, a NOR memory can provide better, more reliable and stable information may be advantageous.

An interface, such as, for example, a universal serial bus (USB) port 48 may be connected to the main controller 44 to provide an interface for modifying data. The USB port 48 may be connected to an external device such that user command information and data stored in the data storage device 36 may be updated, deleted, or otherwise modified as necessary. The main controller 44 may also have a random access memory (RAM) 47 for driving the display device. In certain embodiments, a synchronous dynamic RAM (SDRAM) may be used.

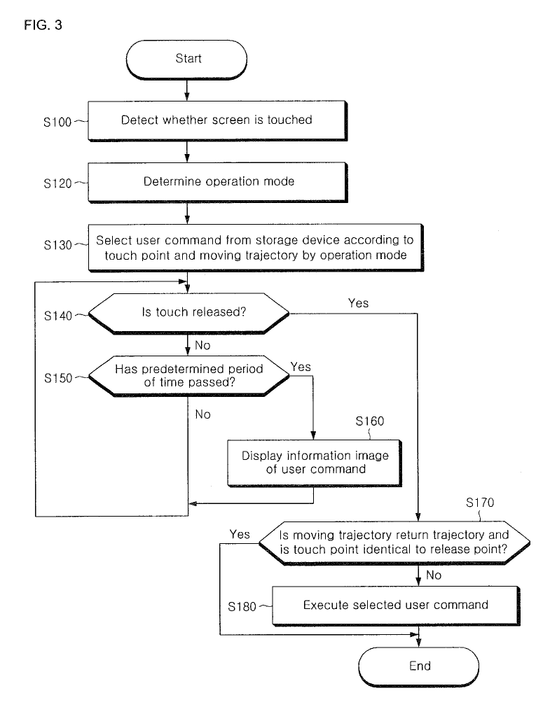

Hereinafter, operation of an embodiment will be described in detail with respect to FIG. 3. The aforementioned may be applied to numerous types of digital equipment, including, but not limited to an MP3 player, PDA, and PMP. However, merely for exemplary purposes and ease of discussion, an MP3 player will be discussed.

As shown in FIG. 3, a touch screen device in accordance with an embodiment as broadly described herein may be operated by touching the detector 12 to input a command. The detector 12 may detect the touch, in step S100 and, further, the detector 12 may detect an initial touch point, a moving trajectory in a case where the touch point moves, and a point where the touch is released. Accordingly, the detector 12 detects information on the points and moving trajectory and transmits the information to the controller 20. The touch detected by the detector 12 may include any type of direct or indirect touch or contact using an appropriate touching implement 60, such as, for example, a finger, a stylus, and the like.

If the detector 12 detects a touch, the controller 20 may determine a current operation mode of the touch screen device, in step S120. The operation mode may be related to a state in which the touch screen device is currently operating, such as, for example, menu selection mode, playback mode, record mode, and other such operating modes. Accordingly, if the operation mode is detected, the associated images currently being displayed on the screen 10 are known. After determining the operation mode, the controller 20 may select a user command stored in the storage device 30 based on the operation mode and the points and moving trajectory, in step S130.

User commands may be classified by the operation mode and associated points and moving trajectory and then stored in the storage device 30. Examples of user commands which may be stored in the storage device 30 for the playback mode are shown in Table 2.

TABLE 2
<Playback Mode>

| Type of moving trajectories | User commands |
|---|---|
| 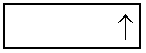 | Volume up |
| 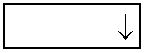 | Volume down |
| 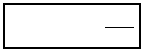 | Play back next music |
| 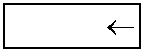 | Play back previous music |
| 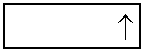 | Skip 10 seconds |
| 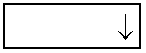 | Rewind 10 seconds |
| 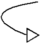 | Play |
| 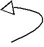 | Reverse |

Table 2 shows only a few exemplary user commands related to the types of operations which may be carried out in one particular exemplary operation mode. However, embodiments may further include a variety of moving trajectories and corresponding user commands in addition to the trajectories and user commands shown in Table 2. Further, the type of moving trajectory shown in Table 2 is shown in the same way as an actual moving trajectory displayed on the screen. However, the controller 20 may actually recognize the moving trajectory using a moving coordinate system.

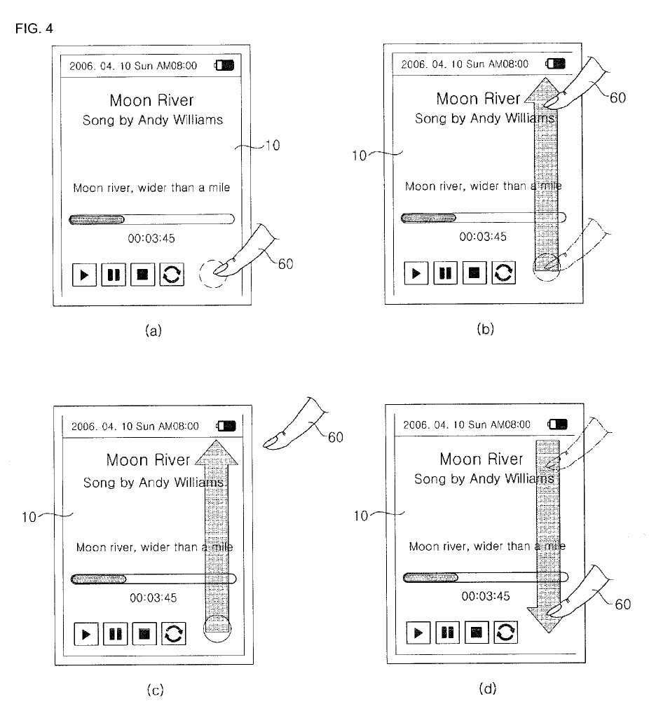

Referring to Table 2, if the device is in the playback mode, the initial touch point is at a lower right portion of the screen 10, and the moving trajectory moves from the lower right portion to an upper right portion of the screen 10, the controller 20 may recognize the above action as a user command to turn up the volume as seen from Table 2 (see also FIGS. 4A and 4B). Thus, the controller 20 may increase the volume as the drag moves up the screen 10. Alternatively, the controller 20 may recognize the drag as a command to increase the volume, but may wait to execute the command until the touch is released. This option may be set as a user preference.

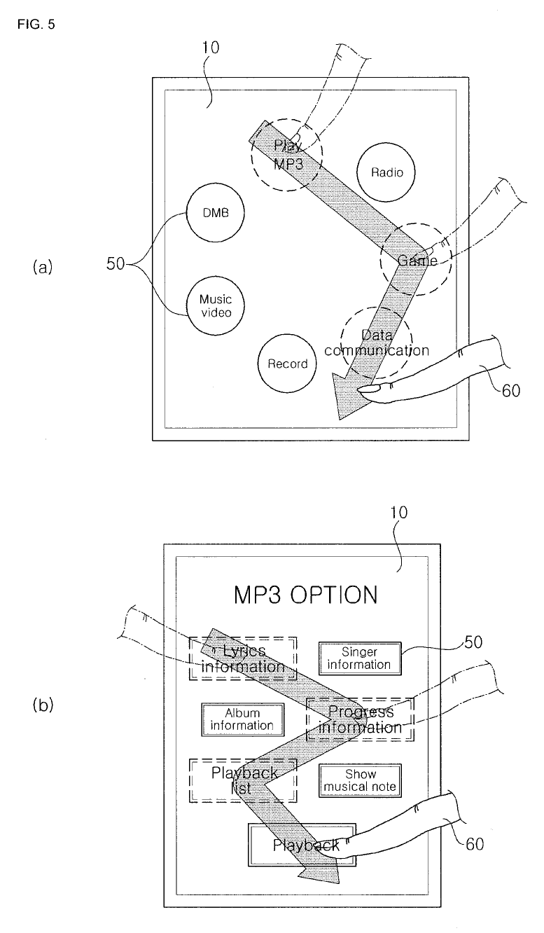

In a different mode of operation, such as, for example, the menu selection mode, a user command may identify selection menus 50 positioned along a path of the moving trajectory and execute the selected menus. The menu selection mode may be a mode in which a list or the like is displayed for selection and execution of specific functions. Accordingly, as shown in FIG. 5A, if selection menus 50, such as, for example, “MP3 playback”, “Game” and “Data communication” are positioned along a particular moving trajectory, the controller 20 may perform a data exchange with a host computer and also may execute a game such that a user can enjoy playing the game on the screen while also listening to a selected MP3 file through an earphone. The controller 20 may execute these selections sequentially, as they are touched along the moving trajectory, or these selections may be executed simultaneously upon release of the touch at the end of the moving trajectory. Again, these options may be set as user preferences.

If, for example, the selections are to be simultaneously executed, then after recognizing the user command, but before executing the user command, the controller 20 may determine whether the touch is released, in step S140. The touch screen device may recognize a user command when the detector 12 is touched, but may not execute the user command when the touch is released. When the touch is released, but before executing the user command, the controller 20 may determine whether the moving trajectory is a return trajectory in which the initial touch point is essentially the same as the release point, in step S170.

If the moving trajectory is a return trajectory and the initial touch point is essentially the same as the release point, the controller 20 may determine the touch and drag as an action to cancel an input entered, for example, by a user in error. In this instance, the controller 20 may not execute the determined user command, but instead await a new input. However, if the moving trajectory is not a return trajectory, and/or the initial touch point is not the same as the release point, the touch release may be determined to be normal and, the controller 20 may execute the determined command, in step S180.

In alternative embodiments, a user may cancel some, but not all, of the menus selected along the path of the moving trajectory. If, for example, a user touches “Play MP3” and “Game” and “Data Communication,” as shown in FIG. 5A, but then decides that only “MP3” and “Game” should be executed, the user may simply return the touch to the “Game” icon before releasing the touch. This partial return trajectory allows a portion of the selected menus to be executed, while canceling any menus selected in error.

If the touch is not released, the controller 20 may determine whether a predetermined period of time has elapsed since the initial touch was detected on the screen, in step S150. If the touch is not released even after a predetermined period of time has elapsed, the controller 20 may determine that a request for additional information related to the user command has been made, and display a corresponding information image related to the user command, in step S160. Then, the controller 20 may again determine whether the touch is released, in step S140. If a predetermined period of time has not elapsed since the initial touch, the controller 20 may again determine whether the touch is released, and execute the user command only when the touch is released.

An example of the operation of embodiments so configured is illustrated in FIGS. 4A-4D, 5A and 5B. Operation of a touch screen device in the playback mode in accordance with an embodiment will be discussed with respect to FIGS. 4A-4D.

First, a user touches the screen 10 with a touching implement 60, such as, for example, a finger. Other touching implements, such as, for example, a stylus pen or the like may also be appropriate. As shown in FIG. 4A, the user touches one side of the screen 10 and upwardly moves the touch as shown in FIG. 4B. When the screen 10 is touched or the touch point is changed on the screen 10, the controller 20 may detect the touch and the change of the touch point and select a relevant user command. After selecting the user command, the controller 20 may stand by until the user releases the touch. As shown in FIG. 4C, the controller 20 may not execute the selected user command until the user releases the touch.

If the user does not release the touch even after the predetermined period of time has elapsed, the controller 20 may display additional information related to the user command indicated by the user's touch and the moving trajectory. In this example, the type of drag may correspond to a user command to turn up the volume as illustrated in Table 2, and thus, the controller 20 may display a corresponding information image such as “Volume Up”.

If the user releases the touch within the predetermined period of time, the controller 20 may simply execute the user command. However, before executing the user command, the controller 20 may examine whether the moving trajectory is a return trajectory and the touch release point is identical to the touch point. By returning to the original touch point, the user may cancel the user command. Therefore, if the user recognizes that an erroneous input has been made while performing the drag action on the detector 12, the user may merely return the drag trajectory to the initial touch point with the finger 60 still in contact with the detector 12, and then release the touch, as shown in FIG. 4D. Therefore, when the moving trajectory is a return trajectory and the release touch point is essentially the same as the initial touch point, the controller 20 may not execute the user command. If the moving trajectory does not draw a return trajectory and the touch is normally released as described above, the controller 20 may execute the selected user command.

Operation of the digital equipment in the menu selection mode is shown in FIGS. 5A and 5B. The operating principle in the menu selection mode is the same as that in the playback mode, but methods of selecting user commands may be different. That is, the user command in the menu selection mode is to execute selection menus 50 existing along the path of the moving trajectory. Thus, as shown in FIG. 5A, if selection menus 50 such as “MP3 playback”, “Game” and “Data communication” exist along the path of the moving trajectory, a command to simultaneously execute the three selection menus 50 may become a current user command.

Then, as shown in FIG. 5B, if the selection menus 50 such as “lyrics information”, “progress information”, and “playback list” exist along the path of the moving trajectory in a playback option selection mode, the user command may be to set a playback option such that lyrics, an image of the progress state, and a playback list are displayed when an MP3 file is played back. More specifically, the touch panel or detector controller 42 may signalize the touch point and movement of a touch and transfer the signal to the main controller 44. In this example, the touch type may include a moving trajectory of the touch. The main controller 44 may determine a touch type, that is, a touch trajectory, received from the touch panel or detector controller 42 and a position of a menu icon displayed on the display 14 in a playback option selection mode, and select all the menus at the points where the touch trajectory and menu icon position overlap each other. The main controller 44 may issue a user command to either sequentially or simultaneously execute the menus selected as such.

The selection menu 50 selected by the user's touch may be displayed in an enlarged state so that the user can easily recognize the selected menu. There are a variety of ways in which an appearance of the menu images may be changed. For example, if a plurality of menu images is selected, the selected menu images may be enlarged and displayed at the moment when a user's touch overlaps a particular menu image. Alternatively, selected menu images may be simultaneously enlarged and displayed after all the user's touches have been completed.

The operation modes and user commands described above are merely exemplary in nature, and it is well understood that numerous other operation modes and user commands may be set and stored in various ways.

Additionally, the various touch points and moving trajectories corresponding to the user commands may be defined by a user based on personal preferences. For example, menus for inputting touch points and moving trajectories corresponding to respective user commands are provided, and the user can input the touches corresponding to the user commands proposed to the user. Thus, the touches and moving trajectories input by the user can be stored and employed in such a way to correspond to the user commands.

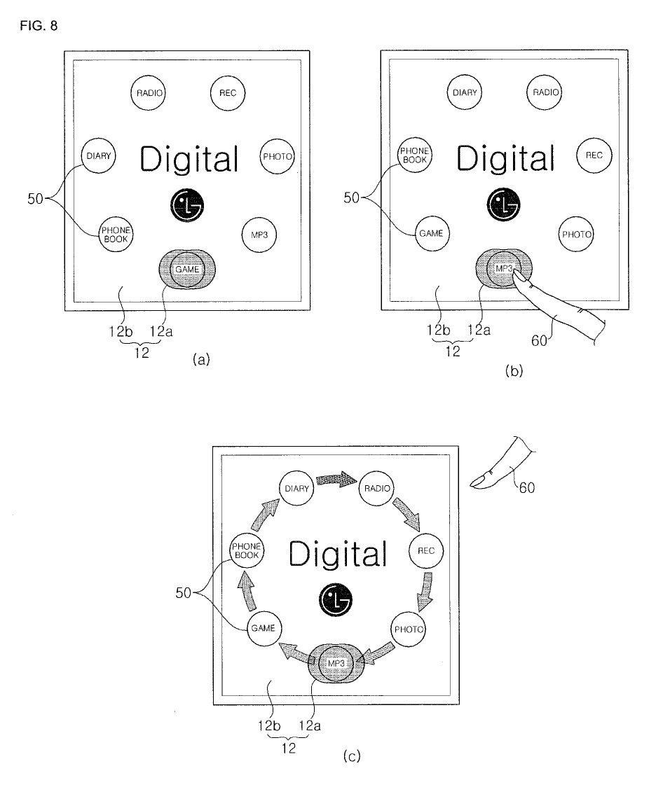

In another embodiment, the controller 20 may allow the detector 12 to be divided into two portions. That is, as shown in FIGS. 8A-8C, the controller 20 may assign one portion of the detector 12 as an execution area 12a, in which a menu 50 corresponding to a particular touch may be executed. The other portion may be assigned as a selection area 12b, in which when the touch is detected, the displayed menus 50 may be sequentially moved to the execution area 12a.

That is, the controller 20 may execute a corresponding menu 50 when a touch is detected at a coordinate corresponding to the execution area 12a and move the menus 50 to the execution area 12a when a touch is detected at a coordinate corresponding to the selection area 12b. In one embodiment, the controller 20 may continuously move the menus 50 while the touch is maintained on the selection area 12b.

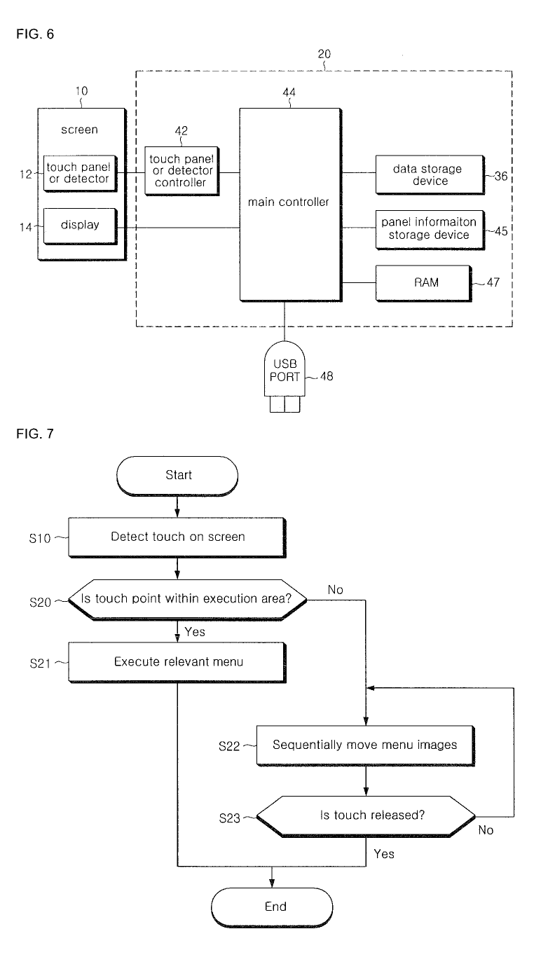

The touch screen device shown in FIG. 6 is similar to the touch screen device shown in FIG. 2. However, in the embodiment shown in FIG. 6, the controller 20 includes a panel information storage device 45 that may store partition information related to the touch screen or detector 12. In certain embodiments, the partition information may be classified by operation mode and may contain information indicative of whether a specific position on the touch screen or detector 12 is included in a selection or moving area 12b or an execution area 12a. Accordingly, the information on whether the respective positions are included in the execution area 12a or the selection or moving area 12b on the basis of coordinate axes may be stored by mode.

Operation of a touch screen device according to an embodiment as broadly described herein will be discussed with respect to the flowchart shown in FIG. 7. As shown in FIG. 7, the operation of the touch screen starts from detecting a screen touch by the detector 12, in step S10.

If the detector 12 detects a touch on the screen 10, the controller 20 may determine whether the touch point is within the execution area 12a, in step S20. The execution area 12a and the selection area 12b may be set beforehand and stored. If the touch point is within the execution area 12a, the controller 20 may execute a menu 50 corresponding to the touch point, in step S21. If the touch point is within the selection area 12b, that is, the portions outside the execution area 12a, the controller 20 may sequentially move images of the menus 50 displayed on the display 10 such that the menus can be positioned within the execution area 12a, in step S22.

The controller 20 may check whether the touch is released after moving the images of the menus 50, in step S23. Then, if the touch is released, the controller 20 may terminate the operation and wait for a new touch input. However, if the touch is not released, the controller 20 may repeatedly perform the steps of sequentially moving the images of the menus 50 and then checking whether the touch has been released. The reason is that the images of the menus 50 may be moved by a desired number of times by continuously maintaining a single touch instead of performing several touches several times when a user intends to move the images of the menus 50 several times.

Next, operation of an embodiment so configured will be explained from the viewpoint of a user, referring to FIGS. 8A-8C.

FIG. 8A shows an example in which the execution area 12a is located at the lower center of the screen 10 and the menus 50 are arranged in the form of a circle with the center positioned at the center of the screen 10. In this state, a user determines a desired menu 50 that the user wishes to execute. For example, when the user wishes to operate an MP3 player, the user may position the “MP3” menu 50 on the execution area 12a. However, since the “GAME” menu 50 is currently positioned on the execution area 12a, the menus 50 should be moved.

Accordingly, the user touches the selection area 12b of the screen 10. FIG. 8B shows that the user touches the selection area 12b. Thus, the menus 50 rotate clockwise, and the “MP3” menu 50 is positioned on the execution area 12a. If a user wishes to record, he/she may continuously touch the selection area 12b until the “REC” menu 50 is positioned on the execution area 12a. After a desired menu 50 has been positioned on the execution area 12a, the user may merely touch the execution area 12a. When the execution area 12a is touched, the controller 20 may execute the relevant menu 50 positioned on the execution area 12a. In this example, the operation mode is changed to an “MP3” mode.

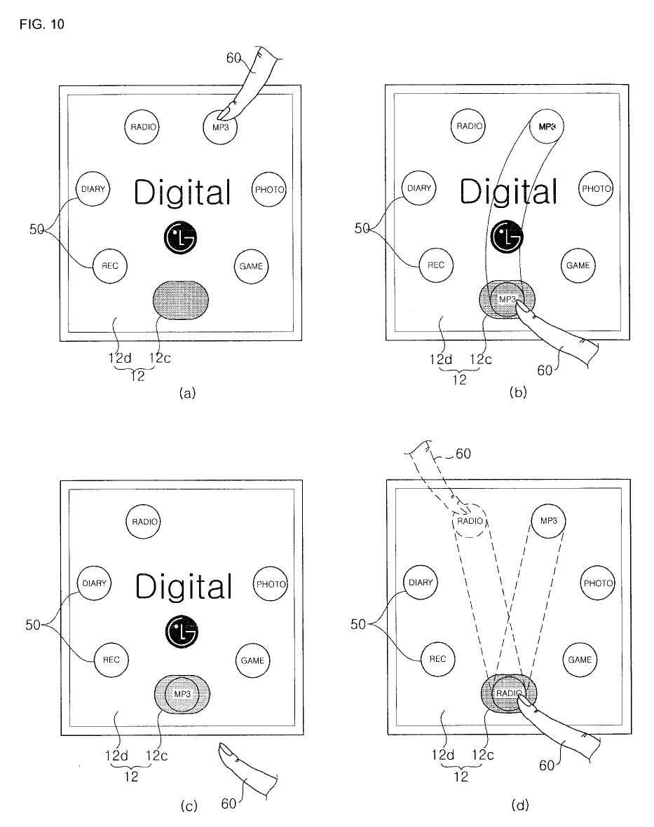

Next, the configuration, operation, and illustration of another embodiment will be described in comparison with those of the previous embodiment with reference to FIGS. 10A-10D. In this embodiment, the controller 20 according to this embodiment may allow the detector 12 to be divided into a moving area 12d and an execution area 12c. When a user touches and moves (hereinafter, referred to as ‘drags’) the menu 50, the moving area 12d may allow an image of the touched menu 50 to be moved along a drag line. Further, the execution area 12c may allow the relevant menu 50 to be executed when the touch is released.

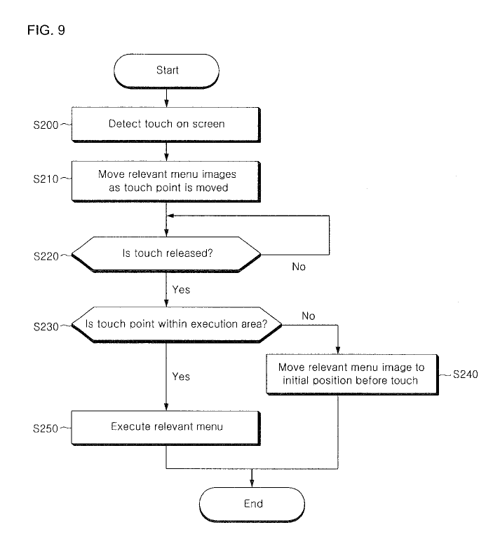

As shown in FIG. 9, this exemplary embodiment may also be operated when the detector 12 detects a touch on the screen 10, in step S200. Then, the detector 12 may also detect a drag line along which the touch is moved. The controller 20 may cause a position of the image of the relevant menu 50 to move along the drag line. That is, the image of the menu 50 may be moved as a touch point is changed, in step S210.

Thereafter, the detector 12 may detect whether the touch is released, in step S220. In one embodiment, the relevant menu 50 may be executed when the touch is released. The release of the touch may be detected to determine whether the relevant menu 50 will be executed.

If the touch is not released, the touching action may be considered to be maintained. Thus, the detector 12 may wait until the touch is released. Only after the touch has been released, the detector 12 may determine whether a release point is on or within the execution area 12c step S230.

If the release point is on the execution area 12c, the controller 20 may execute the relevant menu 50 and then wait for the input of the next touch signal, in step S250. However, if the release point is not on or within the execution area 12c but on the moving area 12d, the controller 20 may not execute the relevant menu 50. In addition, the controller 20 may return the relevant menu 50 to a position before the touch is made, and the controller 20 may also wait for the input of the next touch signal, in step S240. Therefore, if a user recognizes the touch of a wrong menu 50 while dragging the desired menu 50, he/she may stop dragging the relevant menu within the moving area 12d to cancel the execution of the relevant menu 50 such that the relevant menu can be returned to its initial state.

Next, the operation of the embodiment so configured will be explained from the viewpoint of a user, referring to FIGS. 10A-10D.

As shown in FIG. 10A, a user who intends to execute the menu 50 first touches the menu 50 that the user wishes to select. FIG. 10A shows a case in which a user wishes to execute the “MP3” menu 50.

Then, as shown in FIG. 10B, the user may drag the relevant menu 50 from the touch point to the execution area 12c. Next, as shown in FIG. 10C, if the touch is released from the execution area 12c, the corresponding menu 50 may be executed. Further, in a case where the user does not wish to execute the menu 50 while dragging the relevant menu 50, he/she may merely release the touch from the moving area 12d.

In addition, as shown in FIG. 10D, if the other menu is dragged and placed at the execution position while an MP3 play mode is operated, the previous menu may be terminated and an icon indicative of the previous menu may be simultaneously returned to its original position. For example, as shown in FIG. 10D, if a user drags an icon representing a radio listening mode into the execution area while the MP3 play mode is operated, the icon representing the MP3 play mode may be returned to its original position and the radio listening mode executed.

Embodiments may be executed according to an operation mode. That is, in an operation mode in which a menu 50 is selected and executed, the area of the detector 12 may be divided as described above. However, in an operation mode other than the selection of the menu 50, the entire detector 12 may be activated and used.

In the above description, the execution area 12c is set as a fixed position. However, the execution area may be movable.

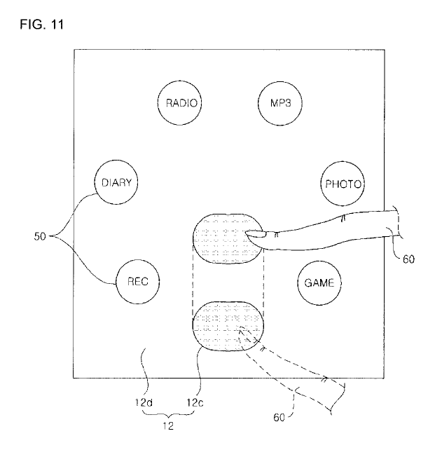

That is, as shown in FIG. 11, while the menu icons are displayed at fixed positions, the user may touch and drag the execution area 12c onto a desired menu icon 50. That is, if the execution area 12c is dragged onto the desired menu icon 50 and the touch is then released, the menu 50 included in the execution area 12c may be executed. In order for the user to easily identify the execution area 12c, the execution area 12c may be displayed in a different color.

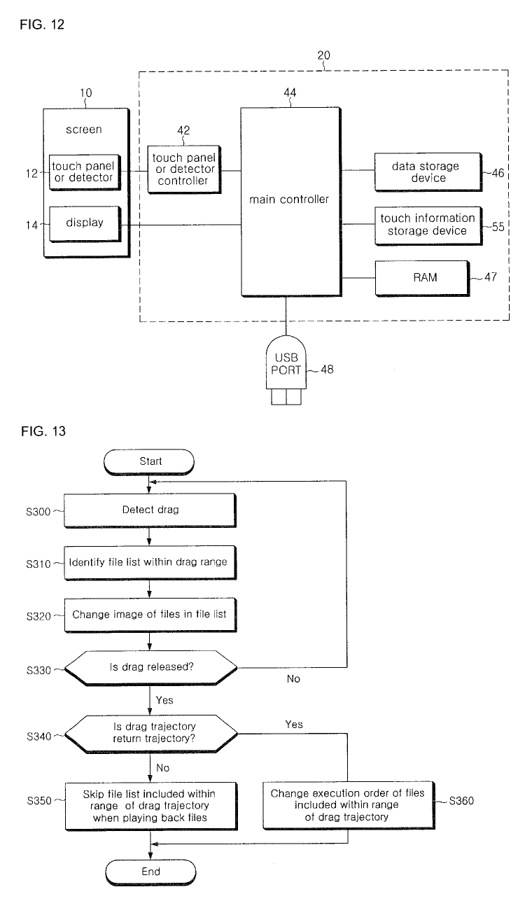

The touch screen device shown in FIG. 12 is similar to the embodiment shown in FIGS. 2 and 6. However, the embodiment shown in FIG. 12 includes a touch information storage device 55 that allows the controller 20 to slip specific files, or to change an execution order of selected files when selecting and executing files. The controller 20 may determine the point and type of the user's drag and then skip the files included within a range corresponding to a drag trajectory. The drag trajectory may be set at a diagonal on a screen. If the drag trajectory is actually a return trajectory, that is, if the touch is maintained through the drag, returned to the initial touch point, and then released at the initial touch point, the detector 12 may change the execution order of the files included within a range corresponding to the drag trajectory, and execute the files in the changed execution order.

If the drag trajectory is performed in a vertical direction, the controller may upwardly and downwardly move (scroll) the file list 70. In this case, the speed and direction of the scroll may correspond to the speed and direction of the drag. The controller 20 may continue the scroll until the touch is released.

Thus, the touch information storage device 55 may store information on an execution command based on a particular touch. The execution command information may be classified by operation mode and may contain execution commands corresponding to specific touch types. Examples of execution commands corresponding to the moving direction and speed of the touch in a certain operation mode are shown in Table 3.

TABLE 3
<Playback List Selection Mode>

| | Speed | | | |
|---|---|---|---|---|
| | 1 S/Cm or | | | 4 S/Cm or |
| Type | less | 1~2 S/Cm | 2~4 S/Cm | more |
| Move | Move | Move | Move | Move |
| downward | playback list | playback list | playback list | playback list |
| from upper | downward | downward | downward | downward |
| right | at speed of 1 | at speed of 2 | at speed of 4 | at speed of 5 |
| | S/Cm | S/Cm | S/Cm | S/Cm |
| Move | Move | Move | Move | Move |
| upward | playback list | playback list | playback list | playback list |
| from lower | upward | upward | upward | upward |
| right | at speed of 1 | at speed of 1 | at speed of 1 | at speed of 1 |
| | S/Cm | S/Cm | S/Cm | S/Cm |

| | |
|---|---|
| Move from | Skip playback list in touched area |
| upper left to | |
| lower right | |
| Move from | Delete playback list in touched area |
| upper right to | |
| lower left | |

A data storage device 46 and RAM 47 may be similar to that discussed above. In alternative embodiments, a portion of the data storage device 46 may be used as the touch information storage device 55. However, a separate touch information storage device 55 may be used. For example, use of a touch information storage device 55 constructed of, for example, a NOR memory can provide better, more reliable and stable information may be advantageous.

Hereinafter, a method of skipping files or changing the execution order of the files and a method of scrolling through a file list will now be discussed with respect to FIGS. 13-16C.

FIG. 13 is a flowchart of a method of skipping execution files in accordance with an embodiment as broadly described herein. First, the system may be activated as the detector 12 detects a drag, in step S300. That is, if an execution file list 70 is displayed on the screen 10, the detector 12 may detect the user's drag on the screen 10. The drag may follow a diagonal shape where both X and Y coordinates are changed. That is, when the diagonal drag is performed, the detector 12 may recognize the diagonal drag as a drag input for skipping files.

If a diagonal drag is performed, the controller 20 may identify files included within a range corresponding to the drag trajectory, in step S310. The range corresponding to the drag trajectory may be a range included within a rectangle defined by the diagonal drag trajectory. For example, if the drag is moved from a coordinate (X1, Y1) to a coordinate (X2, Y2), the range corresponding to the drag trajectory may be a range including the interior of a rectangle having four apexes with the coordinates (X1, Y1), (X2, Y2), (X2, Y1) and (X2, Y2).

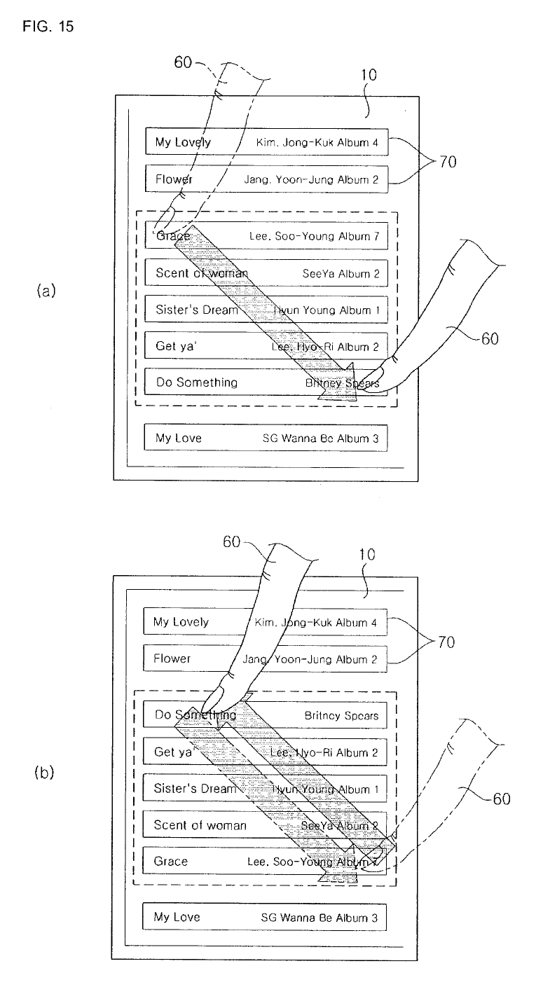

It is noted that, in certain embodiments, as a diagonal drag is performed and the drag reaches the bottom right corner of the screen 10, as shown, for example, in FIG. 15A, the file list 70 may continue to scroll, and the drag may continue further down the file list 70 to include more files within the range marked by the drag as long as the touch is not released. In other embodiments, preferences may be set to limit the length of the diagonal drag to the diagonal of the screen, thus stopping the related scrolling action, if so desired.

Then, the controller 20 may change and display the image of the selected file(s), in step S320. This change of image may include changing an appearance of the selected file(s), such as, for example, colors, fonts, styles of letters, the background color, and the like. This allows a user to easily confirm whether the file(s) intended for selection by the user are the same as the file(s) detected by the detector 12. In certain embodiments, after the file(s) are selected, the controller 20 may check whether the drag is released, in step S330. The file skip command may be executed when the drag is released.

When the drag is released, a command to skip the files and execute the next file may be executed. However, before skipping the files, the controller 20 may check whether a user intends to change an execution order of the files. If the detector 12 detects that the drag trajectory is a return drag trajectory, this may indicate a change in the execution order of the files is desired. Therefore, the controller 20 may check whether the drag trajectory is a return trajectory, in step S340.

If the drag trajectory is not a return drag trajectory, a command to skip the files selected by the drag may be performed when the files in the file list 70 are sequentially executed, in step S350. If the drag trajectory is a return drag trajectory, the execution order of the files included within the range of the drag trajectory may be changed, in step S360. As discussed above, the range of files associated with the drag trajectory may be a range within a rectangle defined by a diagonal equal to a maximum drag distance. That is, the rectangle may be a quadrangle with a diagonal equal to a straight line that connects the start point of the drag to a point having the maximum X and Y coordinates from the start point. The change in execution order of the selected files may be made in various ways. However, the execution order of the files included within the range may be changed in a reverse order. If the files are skipped or their execution order is changed by the drag, the remaining files may be executed as appropriate.

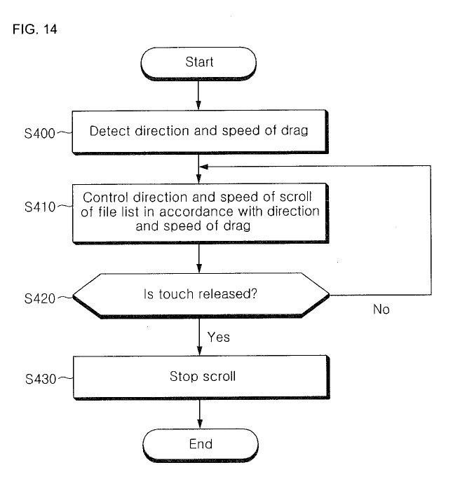

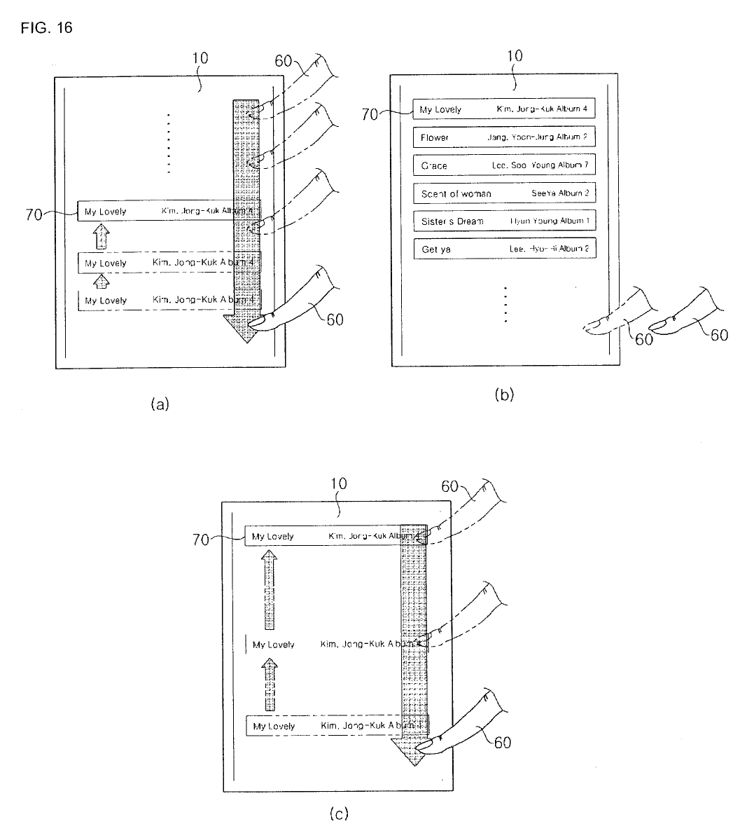

A method of scrolling through the file list 70 is shown in FIG. 14. The system may be activated as the detector 12 detects the user's drag, in step S400. The detector 12 may detect the direction and speed of the drag at the same time. The drag direction may be detected by changes in the coordinate(s) of the drag point. The drag speed may be detected by changes in the coordinate(s) per unit time. It is noted that, although these drags are illustrated as vertical drags in the examples shown in FIGS. 16A-16C, it is well understood that this scrolling may also be done with different orientations of file lists and associated scrolling action. For example, vertical columns of file lists may be scrolled from left to right or right to left using horizontal drags. Likewise, although the drags are shown at the right edge of the screen 10, it is well understood that a drag may be performed at any point within a prescribed active area of the screen 10, as long as the corresponding drag trajectory is followed. For example, the vertical drag illustrated on the right edge of the screen in FIGS. 16A-16C may also be done at a center or left edge of the screen 10, as long as the orientation of the drag remains vertical and the initiation touch point is within a prescribed portion of the screen 10.

If a drag is detected, the controller 20 may scroll through the file list 70 in accordance with the direction and speed of the drag, in step S410. In this example, if the drag direction is upward, the controller 20 may scroll through the file list 70 upward. If the drag direction is downward, the controller 20 may scroll through the file list 70 downward. The scroll direction may also be adjusted based on user preferences, such as, for example, opposite to that which is discussed above. FIGS. 15A-15B illustrate an example in which the drag direction and the scroll direction are opposite to each other.

As discussed above, the scroll speed of the file list 70 may correspond to the drag speed. That is, the file list 70 may be scrolled at a fast speed if the drag speed is fast, while the file list 70 is scrolled slowly if the drag speed is slow. As the file list 70 is scrolled, the detector 30 may detect whether the drag is released, in step S420. If the drag is released, the scroll may also stop, in step S430. However, if the drag is not released, the scroll may be continued at the same speed and direction until the drag is released.

Operation of the touch screen device in accordance the aforementioned method will now be described.

FIGS. 15A-15B illustrates an operation of skipping items or files, and FIGS. 16A-16C illustrates an operation of changing the execution order of items or files, in accordance with embodiments as broadly described herein.

As shown in FIG. 15A, if a user touches the touch screen 10 and drags on the screen in a diagonal direction, a rectangle with a diagonal corresponding to the drag trajectory may be formed. The items or files included within the rectangle are the selected files which will be either skipped or whose execution order may be changed. The items or files selected as such may be displayed in a state in which some aspect of their appearance on the screen is changed. For example, background color of the selected items or files may be changed to easily identify the selected items or files to the user. If the user releases the touch, the selected items or files may be skipped and the next items or files executed. However, if the user does not release the touch at the end of the diagonal, and instead drags in a reverse direction and then releases the drag at the initial touch point, the controller 20 may change the execution order of the items or files included within the range corresponding to the drag trajectory, as shown in FIG. 15B.

To scroll through a list 70 or the items or files, a user touches a portion of the screen 10, for example, one side on the screen 10 as shown in FIG. 16A, and drags in a vertical direction, the list 70 also may scroll downwardly or upwardly. At this time, the scroll speed of the list 70 may be proportional to the drag speed. FIG. 16B shows that the list 70 may scroll slowly since the drag speed is slow, and FIG. 16C shows that the list 70 may scroll fast since the drag speed is fast. As long as the user does not release the touch, scrolling may be continued. However, if the user releases the touch after the drag, scrolling may be stopped, as shown in FIG. 16C.

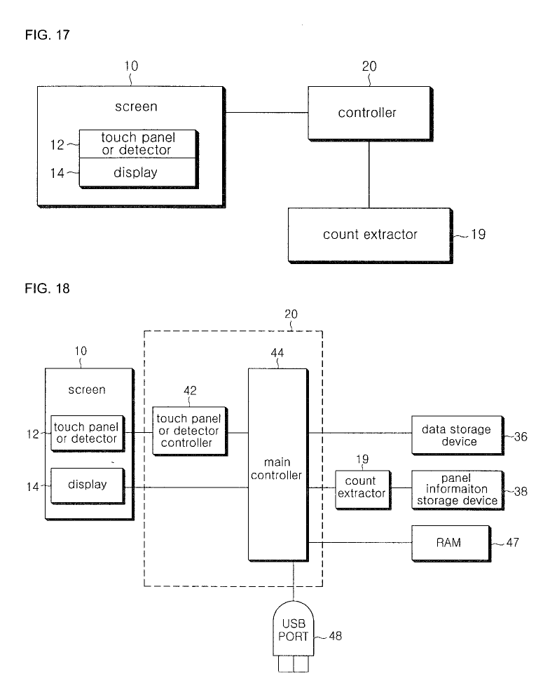

The touch screen device shown in FIG. 17 is similar to those shown in FIG. 1, but may include a count extractor 19 that receives information related to a particular menu selected by the main controller 44 and updates (i.e., increase) a count number of that menu, accordingly. The count extractor 19 may be provided within a microchip of the main controller 44, or may be a separate microchip. Alternatively, the count extractor 19 may be a single module together with a count information storage device 38, as shown in FIG. 18, for storing the count information.

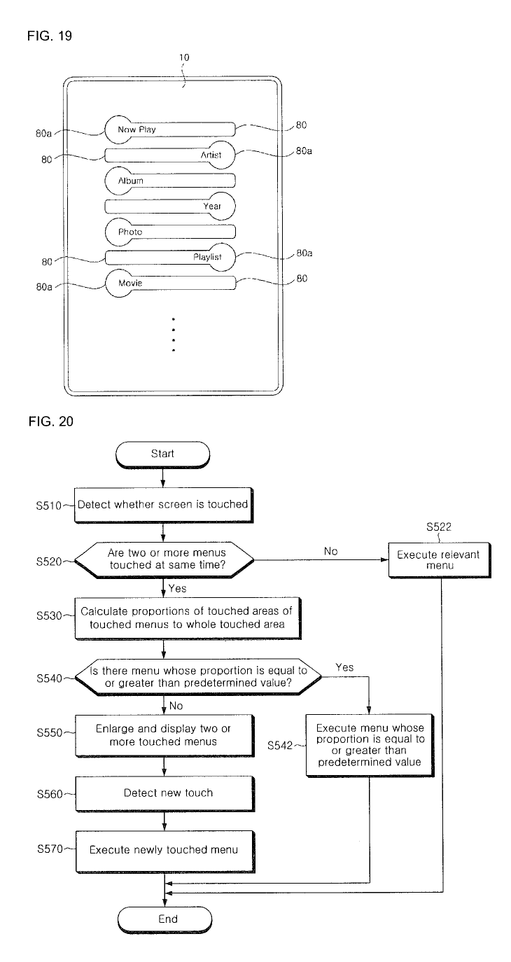

The controller 16 may display the menus using menu bars 80. In the embodiment shown in FIG. 19, each of the menu bars 80 may include an expanded portion 80a at one end thereof such that it may be easily touched with a touching implement 60, such as, for example, a finger or other such appropriate touching implement. The expanded portions 80a may be arranged in an alternating, or zigzag, pattern, as shown in FIG. 19, to maximize the number of menu bars 80 which may be displayed at one time while still maintaining separation between adjacent expanded portions 80a.

More specifically, as shown in FIG. 19, a menu bar 80 provided with an expanded portion 80a at the left end thereof may be arranged below another menu bar 80 provided with an expanded portion 80a at the right end thereof. Therefore, the expanded portions 80a of the two adjacent menu bars 80 do not come into contact with each other, instead maintaining a degree of separation therebetween. The expanded portion 80a may be a portion on which the touching implement 60, such as, for example, the finger, actually touches. Thus, in certain embodiments, the controller 20 may control the touch screen device to allow a relevant menu to be executed when an input is made through the expanded portion 80a, considered an active portion in this particular instance, but a relevant menu not to be executed when an input is made at a portion of the menu bar 80 other than the expanded portion 80a, considered an inactive portion in this particular instance. In other, alternative embodiments, a bar portion of the menu bars 80, instead of or in addition to the expanded portions 80a, may be active and able to receive input. In still other alternative embodiments, a combination of these may be appropriate, based on a particular application.

The controller 20 may be connected to the count extractor 19 to count the number of touches on a menu bar 80. More specifically, the count extractor 19 may be connected to the controller 20 and the detector 12 to count the number of touches on the respective menu bars 80 and to provide the controller 20 with the count results. This allows the controller 20 to reconfigure an arrangement of the menu bars 80 based on the data value received from the count extractor 19. For example, the count results may cause the most used menu bar 80 to be placed in the most easily accessible location on the touch screen 10. Other arrangements may also be appropriate, based on user preferences.

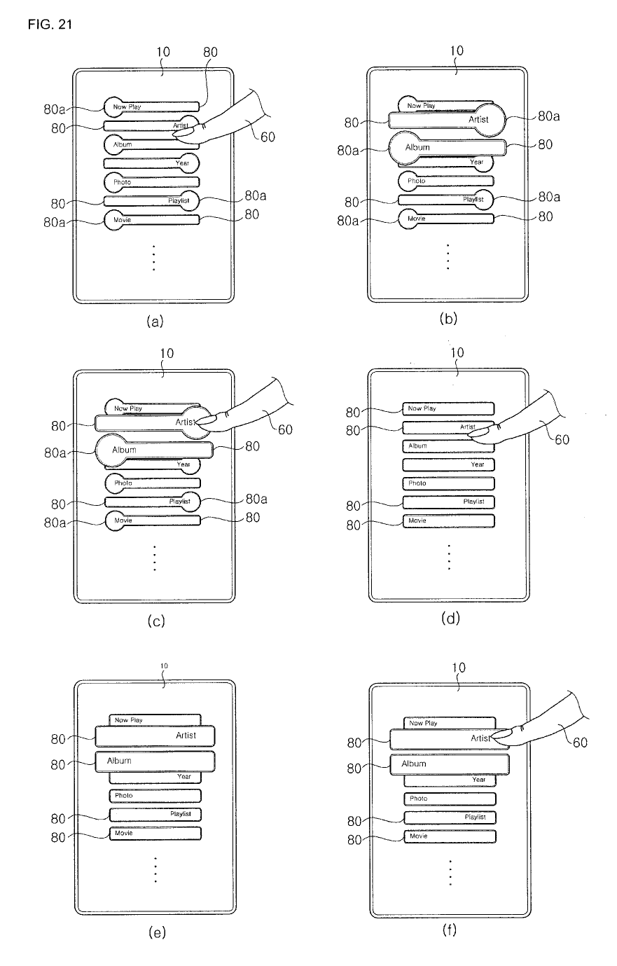

Further, although for exemplary purposes, the menu bars 80 shown in FIGS. 19 and 21A-21C are shown arranged horizontally on the touch screen 10, is it well understood that an orientation of the menu bars 80 could be adapted based on user preferences. For example, the menu bars 80 could be arranged in a vertical direction, with the expanded portion 80a alternating between a top and a bottom portion of the touch screen 10.

In alternative embodiments, image information indicting a function of the relevant menu bar 80 may be displayed on a portion of the menu bar 80 and/or the expanded portion 80a. This image information may include, for example, text, and/or a variety of icons corresponding to the function of the particular menu bar 80. Likewise, appearance of the menu bars 80/expanded portions 80a may be further altered to include, for example, different colors, shading, outlining and the like to further enhance readability of a menu list may be improved relative to when only the text is displayed.

The controller 20 may also perform a function of correcting input errors when input errors are detected by the detector 12. For example, when touch inputs corresponding to two or more menus, and, in particular, to active areas of two or more menus, are applied to the detector 12, the controller 20 may request clarification/selection of a correct menu 80 so as to correct the input error. A method of correcting input errors will be described in detail when discussing operation of the touch screen device.

Hereinafter, the operation of the touch screen device in accordance with an embodiment as broadly described herein will be described in detail with reference to FIG. 20. It is well understood that this method of operation may be applied whether or not the menu bars 80 include expanded portions 80a, and regardless of an orientation of the menu bars 80.

As shown in FIG. 20, the detector 12 may detect a touch on the screen 10, in step S510. Menus in the form of menu bars 80, either with or without expanded portions 80a are displayed so that a user may select a desired menu bar 80 by touching the expanded portion 80a. In certain embodiments, a touch input may be made only through the expanded portions 80a, considered active portions of the menu bars 80, in order to minimize input errors.

In alternative embodiments in which the active area includes not only the expanded portion 80a, but also at least a portion of the menu bar 80, or in which the menu bars 80 do not include expanded portions 80a, the controller 20 may operate to detect and correct input errors. More specifically, if the detector 12 detects a touch, the controller 20 may check whether two or more menus are touched at the same time, in step S520, to determine whether there is an input error. If only one menu bar 80/expanded portion 80a is touched, it is a normal input without errors, and thus, a relevant menu may be executed in step S522.

However, if touch inputs are applied to two or more menu bars 80/expanded portions 80a, the controller 20 may calculate proportions of touched areas of the respective touched menu bars 80/expanded portions 80a to the whole touched area, in step S530. This allows the controller 20 to determine that very weakly touched menu bars 80/expanded portions 80a were likely touched in error.

Next, the controller 20 may check whether there is a menu bar 80/expanded portion 80a where more than a predetermined proportion of the whole touch area is contained within an active portion, in step S540. The predetermined proportion may be a value close to 100%. However, the predetermined proportion may be set to other values, such as, for example, a value between 70% and 95. The larger the predetermined proportion is set, the more sensitively the screen 10 will respond to an input. However, this increased sensitivity may cause a larger number of false, or incorrect error determinations. On the other hand, a smaller predetermined proportion may result in a simplified input procedure, but sensitivity to the input is lowered.

When there is a menu bar 80 that has a touch area greater than or equal to the predetermined proportion, the controller 20 may recognize that the menu bar 80 has been selected/input, and execute the relevant menu, in step S542. However, when there is no menu bar 80 that has greater than or equal to the predetermined proportion of the whole touch area, the touched menu bars 80 which have been touched, for example, two menu bars 80, as shown in FIGS. 21B-21C, may be enlarged and displayed, in step S550. This is to notify a user that inputs for two menus have been entered and to prompt a new input by the user so as to execute the correct menu. Thereafter, the controller 20 may detect the new touch input, in step S560, and execute a menu corresponding to the new touch input, in step S570.

New touch inputs may be made in a variety of ways. For example, all portions on the touch panel other than the enlarged and displayed menu bar(s) 80 may be rendered inactive to prevent touch input errors that may repeatedly occur when another new input is entered. That is, if a menu bar 80 is enlarged and displayed, only the enlarged menu bar(s) 80 may be executed through a user's touch while other portions of the display are rendered inactive, and thus not executed even though a user may touch the other portions.

In alternative embodiments, if a touch is detected on portions other than the enlarged menu bar(s) 80, the display may be returned to a previous display before the menu bar(s) 80 were enlarged, in one embodiment within a predetermined amount of time. In other alternative embodiments, the display may be returned to its previous form if no new touch input is received within a predetermined amount of time.

In still other alternative embodiments, when two menu bars 80 are enlarged, the screen may be divided into two halves, allowing any touch detected on an upper portion to select the upper menu bar 80, while any touch detected on a lower portion to select the lower menu bar.

Next, operation of the touch screen device in accordance with embodiments will be described with respect to the illustrative examples shown in FIGS. 21A-21C.

As shown in FIGS. 21A and 21C, input errors occur when a user touches two or more menu bars 80 at the same time. If, for example, two menu bars 80 are touched at the same time, the controller 20 may cause the two menu bars 80 to be enlarged and displayed, as shown in FIGS. 21B and 21D. In this example, it is assumed that neither of the two touched menu bars 80 has a dominant proportion of the whole touch area, or a proportion which is greater than the predetermined proportion of the whole touch area. That is, if one of the touched menu bars 80 has, for example, more than 90% of the whole touch area and the other is small by comparison, the controller 20 may simply execute the menu corresponding to the menu bar 80 which has more than 90%. However, if there are no dominant menu bars 80, the user may easily touch a desired menu bar 80 from among the enlarged and displayed menu bars 80, as shown in FIGS. 21C and 21F, and the controller 20 executes the newly touched menu.

In certain embodiments, the controller 20 may display a variety of images, including the execution menus, through display windows. That is, the controller 20 may display a plurality of windows containing images in an overlapped manner (hereinafter, referred to as a ‘toggle mode’). The display windows may be arranged such that they do not completely overlap one another, so that some edges or corners thereof remain uncovered.

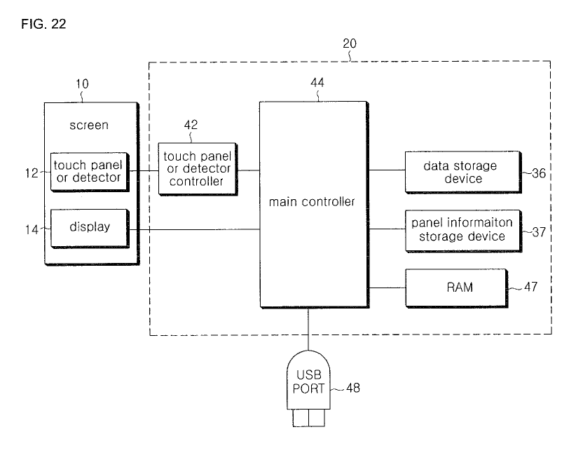

The touch screen device shown in FIG. 22 is similar to the touch screen devices discussed above, but may include an image storage device 37 for storing information on a variety of images to be displayed on the display 14 connected to the main controller 44. The image storage device 37 may include menus in the respective operating modes and stores images representing the modes and menus.

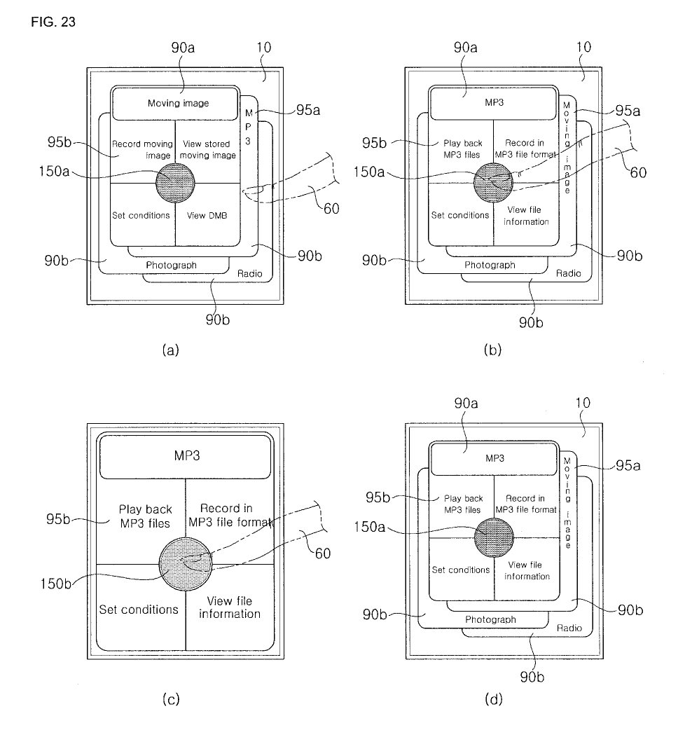

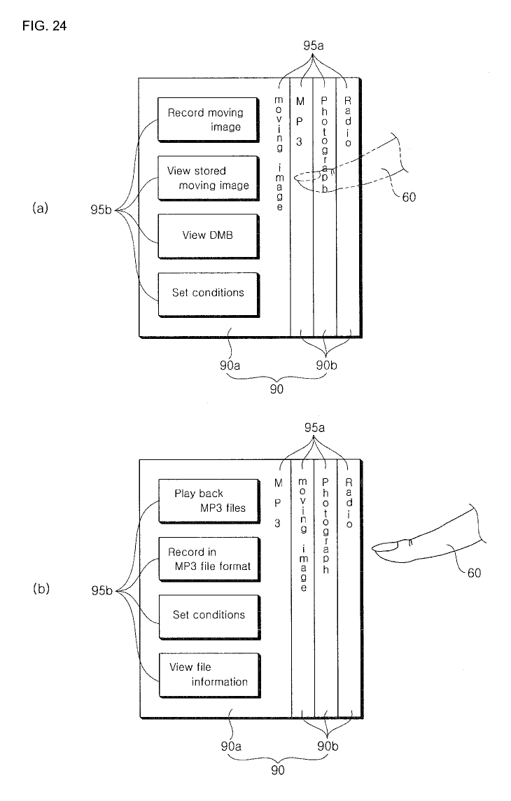

FIGS. 23A-23D are exemplary views showing execution menus displayed in the touch screen device according to an embodiment, and FIGS. 24A-24D are exemplary views showing execution menus displayed according to another embodiment.

As shown in FIG. 23A, a plurality of display windows 90 may be displayed on the screen 10. The display windows 90a and 90b may be displayed in an overlapped manner. In such a case, the underlying display windows 90b placed under the overlying display window 90a may be displayed in such a manner that some portions thereof are not covered. Execution menus 95a indicating the respective display window 90a is shown on some portions of the underlying display windows 90b which are placed under the overlying display window but can be seen from the outside.

Further, as can be seen in FIG. 23A, a title of the overlying display window 90a, in this example “Moving image” may be displayed at a topmost portion of the display window 90a. Only titles of the underlying display windows 90b may be displayed.

In this embodiment, the execution menus have a tree structure. That is, there are upper execution menus 95a which contain the detailed lower execution menus 95b, respectively. In addition, the lower execution menus 95b also contain detailed sub-execution menus, respectively. For convenience of explanation, each level is referred to as a layer. In other words, the execution menus 95a exist on a first layer, and the detailed execution menus 95b of a second layer exist under each of the execution menus 95a of the first layer. In the same manner, execution menus of third and fourth layers exist under the execution menus of the second and third layers, respectively.

Table 4 shows an example of the execution menus having a tree structure according to layers.

TABLE 4

| Layer 1 | Layer 2 | Layer 3 |
|---|---|---|
| Moving | Record moving image | Omitted |
| image | View stored moving image | Omitted |
| | View DMB | Omitted |
| | Set conditions | Set storage method |
| | | Set image quality |
| | | Set DMB receiving conditions |
| | | Set playback conditions |
| MP3 | Play back MP3 files | Omitted |
| | Record in MP3 file format | Omitted |
| | View file information | Omitted |
| | Set conditions | Omitted |

| | |
|---|---|
| Photograph | Omitted |
| Radio | Omitted |

The respective display windows 90a and 90b show the execution menus belonging to the same layer. That is, the execution menus 95a, such as “moving image”, “MP3”, “photograph” and “radio” which belong to the first layer, are displayed on the display windows 90b.

However, the execution menus 95b (“record moving image,” “view stored moving image,” “view DMB” and “set conditions”) of a lower layer (a second layer) belonging to the execution menu 95a (“moving image”) are displayed on the overlying display window 90a. Here, if an execution menu 95b displayed on the overlying display window 90a is touched, the controller 20 may execute the relevant menu. At this time, the menu may be executed only through the execution menus 95b displayed on the overlying display window 90a.

Thus, in this embodiment, if the underlying display window 90b placed under the overlying display window 90a is touched in a state where the execution menus are displayed on the display windows 90a and 90b in a toggle mode, the touched display window 90b may be displayed as the overlying display window.

If the display window corresponding to “MP3” is touched as shown in FIG. 23A, the “MP3” display window may be displayed on the overlying layer as shown in FIG. 23B. Then, the lower execution menus 95b of the “MP3” menu, such as “playback MP3 files”, “record in MP3 file format”, “view file information” and “set conditions” are displayed on the “MP3” display window.

In one embodiment, if the touch is a double touch in which a display window is touched twice within a predetermined period of time, the toggle mode may be canceled and the double touched display window displayed on the display in a full size. A state where the toggle mode is canceled is shown in FIG. 23C.

Further, a toggle mode cancel area 150a for canceling the toggle mode may be provided at a portion of the display window 90a. The toggle mode cancel area 150a may cancel the toggle mode when the touch is input in the toggle mode. The embodiments of FIGS. 23A-23D show the toggle mode cancel area 150a provided at a center of the display window 90a. For example, if the toggle mode cancel area 150a is touched in a state shown in FIG. 23B, the toggle mode may be canceled and the touched display window 90a displayed on the screen in a full size as shown in FIG. 23C.

A toggle mode selection area 150b may be provided at a portion of the display window 90a in which the toggle mode is canceled. The toggle mode selection area 150b may receive a touch and switch a display mode to the toggle mode. FIG. 23C shows the toggle mode selection area 150b provided at the center of the display window. For example, if the toggle mode selection area 150b of FIG. 23C is touched, the display mode may be switched to the toggle mode as shown in FIG. 23D.

The toggle mode cancel area 150a and the toggle mode selection area 150b may be displayed in the same region. That is, a portion functioning as the toggle mode cancel area 150a in the toggle mode may be operated as the toggle mode selection area 150b when the toggle mode has been canceled.

There are a variety of ways to perform the toggle mode according to embodiments. FIGS. 24A-24B show as an embodiment implemented using another display window.

As shown in FIG. 24A, display windows 90a and 90b in this embodiment may be displayed in such a manner that execution menus 95a may be shown at the sides of the display windows. Menu items of the execution menus 95a and 95b may be the same as those described in the previous embodiment(s). If an underlying display window 90b displayed under an overlying display window 90a is touched, the touched display window 90b may be displayed to be an overlaying display window.

That is, if an “MP3” execution menu 95a is touched in a state shown in FIG. 24A, an “MP3” display window may be displayed as an overlying display screen, in this embodiment, as shown in FIG. 24B. At the same time, lower execution menus 95b of the “MP3” execution menu 95a may be displayed on the overlying display window. Although the toggle mode cancel and selection areas are not illustrated and described in this embodiment, the cancel and selection areas may be applied thereto in the same manner as the previous embodiment.

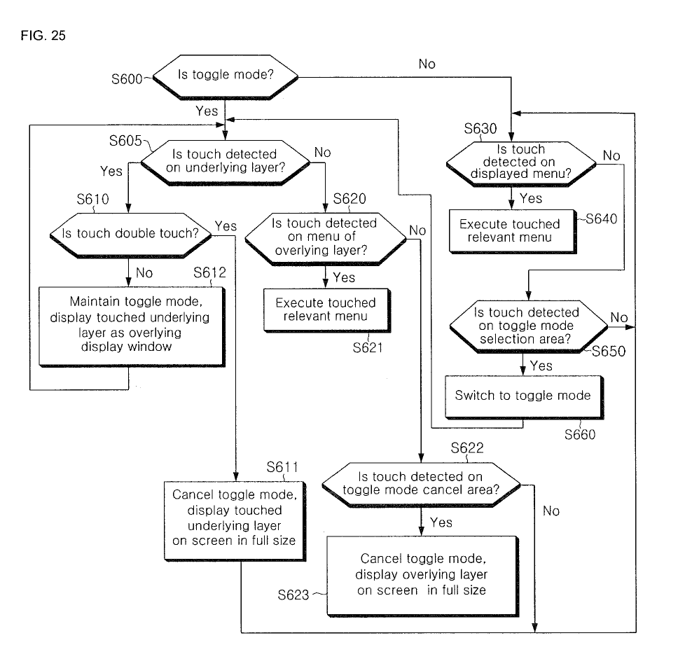

Hereinafter, an execution sequence will be described with reference to the flowchart shown in FIG. 25.

As shown in FIG. 25, it may be determined whether the display device is currently in a toggle mode, in step S600. If it is determined that the display device is in a toggle mode, it may then be determined whether a touch is detected on an underlying layer, in step S605. If it is determined that a touch is detected on the underlying layer, it may then be determined whether the touch is a double touch, in step S610.

If the touch is a double touch, the display window 90b of the touched underlying layer may be displayed on a screen in a full size after the toggle mode has been canceled, and a full screen mode maintained, in step S611. At this time, if the touch is not a double touch, the display window 90b of the touched underlying layer may be displayed as an overlying display window, and the toggle mode maintained, in step S612. On the other hand, if it is determined in step S605 that a touch is not detected on the display window 90b of an underlying layer, it may then be determined whether a touch is detected on a menu of the display window 90a of the overlying layer, in step S620.

If it is determined that a touch is detected on a menu, the detected menu may be executed, in step S621. However, if a touch is not detected on a menu, it may be determined whether a touch is detected on a toggle mode cancel area, in step S622.

If it is determined in step S622 that a touch is detected on the toggle mode cancel area, the display window 90a of the overlying layer may be displayed on the screen in a full size after the toggle mode has been canceled, and the full screen mode maintained, in step S623. On the other hand, if it is determined in step S600 that the display device is currently not in the toggle mode but in the full screen mode, it may then be determined whether a touch is detected on a displayed menu, in step S630.

If it is determined in step S630 that a touch is detected on a displayed menu, the touched menu may be executed, in step S640. However, if a touch is not detected on a displayed menu, it may be determined whether a touch is detected on a toggle mode selection area, in step S650.

If it is determined in step S650 that a touch is detected on the toggle mode selection area, the display may be switched to the toggle mode such that the toggle mode may be maintained, in step S660. However, if a touch is not detected on the toggle mode selection area, the full screen mode may be maintained.

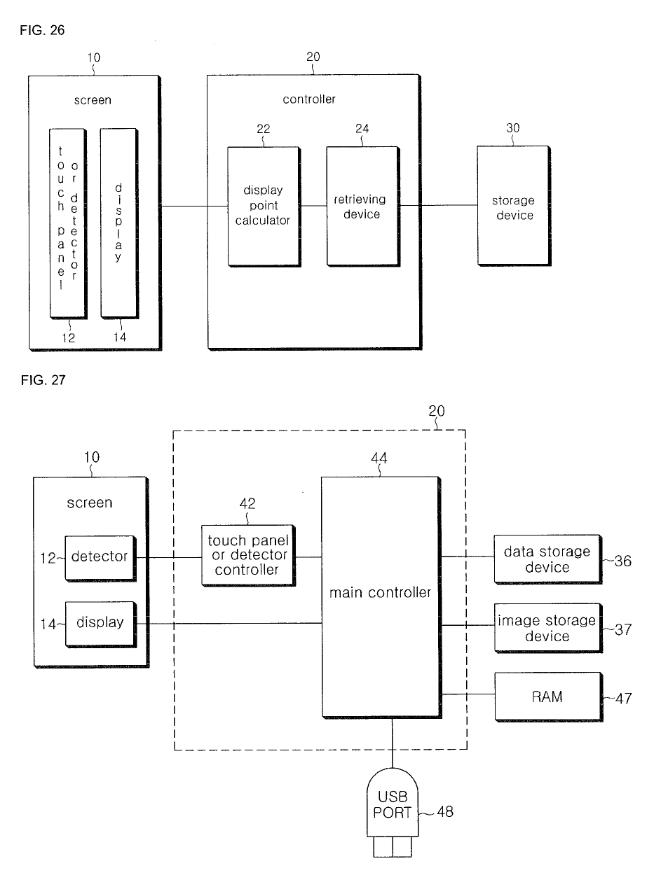

The touch screen device shown in FIG. 26-27 is similar to the touch screen devices discussed above. However, the embodiment shown in FIGS. 26-27 may also include a display point calculator 22 and a retrieving device 24. The display point calculator 22 may calculate a point on the screen 10, on which a menu 50 is displayed, in accordance with a detection signal applied from the detector 12. In addition, the retrieving device 24 may retrieve images, such as icons or texts, which are previously assigned, in accordance with the selected menus touched, for example, by the finger 60 or stylus pen, among the menus 50 displayed on the screen 10, from the image storage device 37.

Therefore, the controller 20 may display the image retrieved from the retrieving device 24 on the moving trajectory between a point calculated by the display point calculator 22 and a point where the menu 50 is selected. The displayed icon may be displayed in various ways, such as a single icon, a combination of a plurality of icons, or an iteration of the plurality of icons.

As shown in FIG. 26, the controller 20 may be connected to the storage device 30 for providing images to the retrieving device 24. The image storage device 37 shown in FIG. 27 may be provided with a hard disk or memory in which, for example, operation control methods, displaying methods, and/or images are stored. The images may include, for example, trace images, icons, pictures, photographs and avatars, and words, sentences, or texts, which are previously assigned in accordance with the menus 50.

More particularly, the icons may be constructed in the form of a symbol or a small picture using, for examples, symbols, characters, figures, or graphics to represent the functions of various kinds of, for example, programs, commands, and data files, instead of characters. In other words, icons with special features may be displayed such that even users of different languages may use the functions.

Such icons have been recently developed in a variety of forms, such as emoticons or face marks. The emoticons may be constructed in a variety of forms, from a type using simple symbols to a type using complex graphics. Accordingly, in disclosed embodiments, the icons related to the menus 50 may be previously assigned and stored in the storage device 30.

A data storage device 36 for storing, for example, MP3 files may be connected to the main controller 44. For example, a NAND memory capable of rapidly and easily storing and reading out a large amount of information may be used as the data storage device 36.

A portion of the data storage device 36 may be used as the image storage device 30. However, providing a separate image storage device 30 constructed of a NOR memory that is relatively superior in the stability of information may be advantageous.

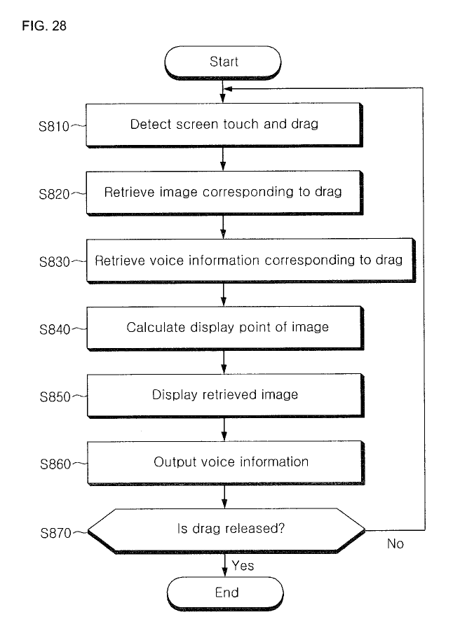

FIG. 28 is a flowchart of a method of operating a touch screen device according to an embodiment as broadly described herein. As shown in FIG. 28, the operation of the touch screen device starts from detecting a touch or drag on the screen by the detector 12, in step S810.

If the detector 12 detects a touch on the screen 10, the retrieving device 24 in the controller 20 may identify a drag type and retrieve an image corresponding to the identified drag type from the image storage device 37, in step S820. The image may be, for example, a trace image 50a showing a drag trajectory, an icon image 50b, or a text image 50c.

The trace image 50a may be displayed along the drag trajectory. Further, the trace image may gradually fade away as a predetermined time period passes. Further, the retrieving device 24 may further retrieve voice information together with the image, in step S830. In this case, the voice information may be stored in the image storage device 37. The retrieving device 24 may retrieve the voice information in accordance with the drag moving trajectory.

After retrieving the image, the display point calculator 22 may calculate a point where the image is displayed, in step S840. Thereafter, the controller 20 may display the image at the calculated point, in step S850. The image may include at least one of a trace image 50a, icon image 50b, or text image 50c.

At the same time, the controller 20 may output voice information, in step S860. That is, in certain embodiments, voice information may be selectively transmitted.

Next, the controller 20 may determine whether the drag is released, in step S870. The reason that it is determined whether the drag has been released is that the display of the image may be terminated if the drag has been released, or the display point or type of the image may be changed if the drag is maintained.

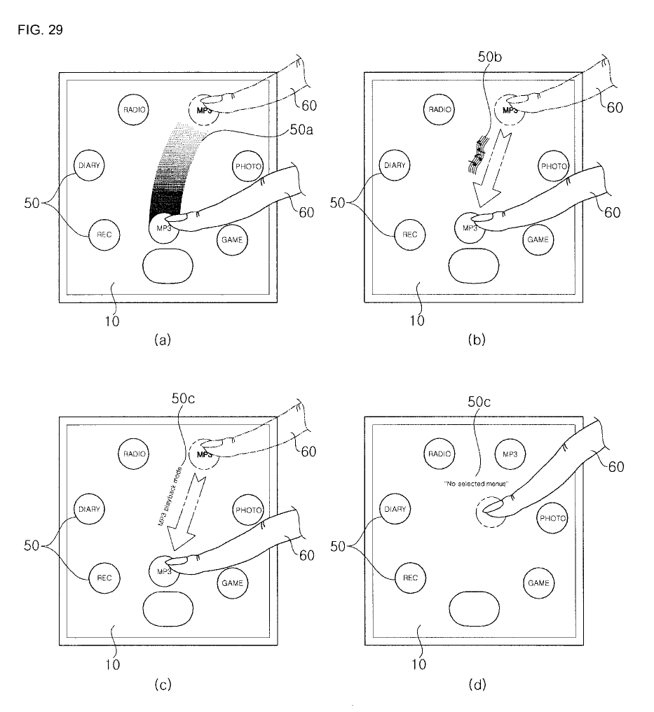

Hereinafter, operations of another embodiment will be described with respect to FIG. 29A, which is an exemplary view showing a trace image 50a displayed on a touch screen device according to an embodiment, FIG. 29B, which is an exemplary view showing an icon image 50b displayed on a touch screen device according to an embodiment, and FIG. 29C, which is an exemplary view showing a text image 50c displayed on a touch screen device according to an embodiment.

As shown in FIG. 29A, if a finger 60 touches a desired menu 50 and drags the selected menu to a predetermined point in a menu selection mode, a trace image 50a may be displayed along the drag moving trajectory. In this example, the trace image 50a may gradually fade away as time passes. As shown in FIG. 29A, therefore, a more blurred trace image may be displayed as the trace image becomes farther away from the image of the menu 50.

On the other hand, FIG. 29B shows an icon image 50b displayed. There are a variety of icon images 50b which may be selected in accordance with the contents of the selected menus 50. That is, as shown in FIG. 29B, since a user has selected the “MP3” menu 50, an image indicating music may be displayed.

Alternatively, FIG. 29C shows a text image 50C displayed. The text image 50c may be descriptive of the selected menu 40. As shown in FIG. 29C, therefore, a text image 50c of “MP3 playback mode” describing the menu 50 may be displayed when the “MP3” menu 50 has been selected.

FIG. 29D shows a text image 50c displayed when no menu 50 is selected in the menu selection mode. As shown in FIG. 29D, when no menu 50 is selected, a text image 50c describing the above circumstance may be displayed. The text image 50c of “No selected menus” may be displayed by way of example, as shown in FIG. 29D.

Alternatively, an image may be displayed for a predetermined period of time and then the image may be changed. In one embodiment, the image may be changed based on a distance of the movement or drag.

FIGS. 29A-29D show that embodiments are operated in a menu selection mode by way of example. However, the disclosed embodiments may be implemented in various modes of an MP3 player and may also be generally employed in digital equipment mounted with a touch screen device.

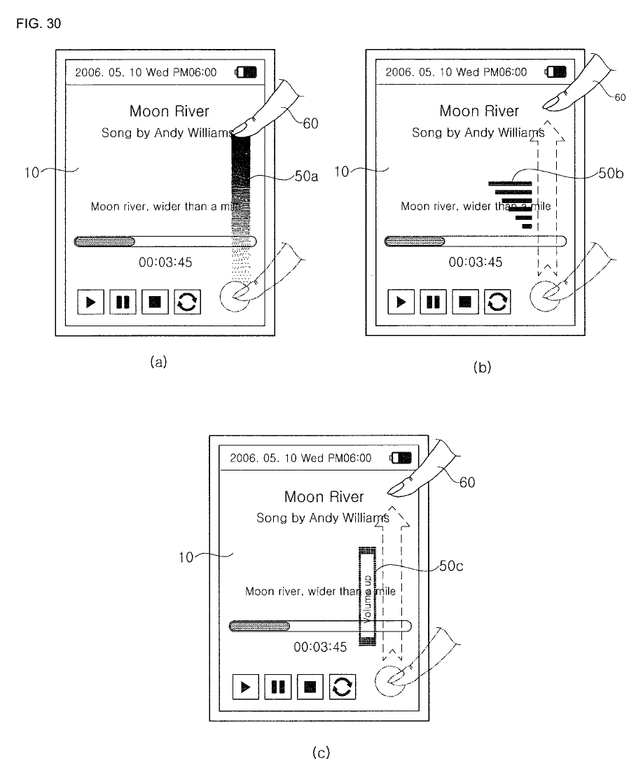

FIGS. 30A-30C show an embodiment operated in a file playback mode of an MP3 player. In such a case, a user drag is shown as an example to correspond to a user command to turn up the volume of the MP3 player.

As shown in FIG. 30A, if a drag is executed corresponding to the volume-up in the playback mode, a trace image 50a may be displayed along the moving trajectory of the drag. In one embodiment, the trace image 50a may gradually fades away as time passes.

Further, an icon image 50b may be displayed as shown in FIG. 30B. There are a variety of icon images 50b which may be selected to be equivalent to the user command corresponding to the drag. That is, an image 50b depicting an increase of volume of the MP3 player may be displayed as shown in FIG. 30B.

In addition, FIG. 30C shows a text image 50c displayed. The text image 50c may be descriptive of a user command corresponding to the drag. Accordingly, a text image of “Volume Up” may be displayed in FIG. 30C.

In certain embodiments, when the screen 10 is touched or the touch point is changed on the screen 10, the controller 20 may detect the touch and the change of the touch point and select a relevant user command. After selecting the user command, the controller 20 may stand by until the user releases the touch. If the user does not release the touch even after a predetermined period of time has elapsed, the controller 20 may display additional information related to the user command indicated by the user's touch and the moving trajectory. In this example, the type of drag corresponds to a user command to turn up the volume, and thus, the controller 20 may display a corresponding information image such as “Volume Up.”

If the user releases the touch within the predetermined period of time, the controller 20 may simply execute the user command. However, before executing the user command, the controller 20 may examine whether the moving trajectory is a return trajectory and the touch release point is identical to the touch point. By returning to the original touch point, the user may cancel the user command. Therefore, if the user recognizes that an erroneous input has been made while performing the drag action on the detector 12, the user may merely return the drag trajectory to the initial touch point with the finger 60 still in contact with the detector 12, and then the user may release the touch. Therefore, when the moving trajectory is a return trajectory and the touch release point is essentially the same as the initial touch point, the controller 20 may not execute the user command. If the moving trajectory may not draw a return trajectory and the touch is normally released as described above, the controller 20 may execute the selected user command.

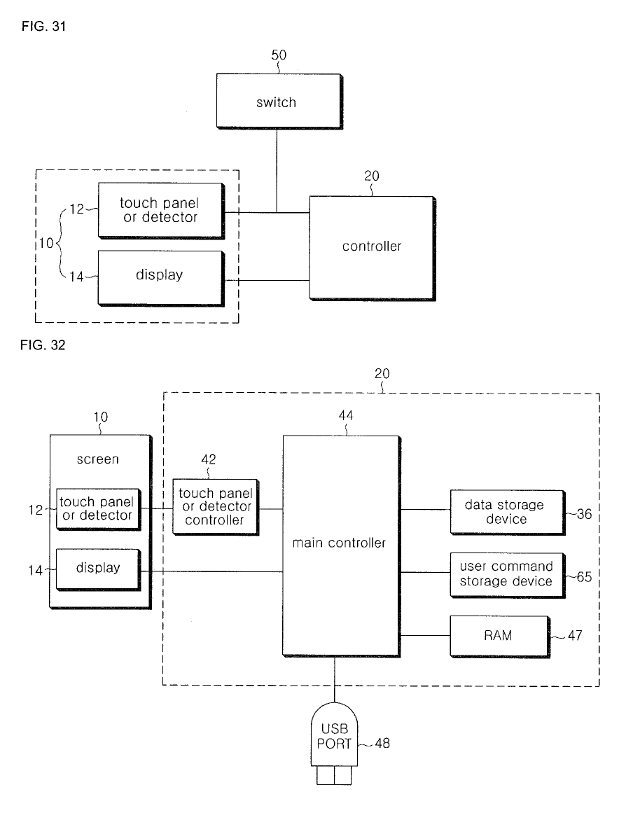

The touch screen device shown in FIGS. 31-32 is similar to the touch screen devices discussed above. However, the embodiment shown in FIGS. 31-32 may also include a switch 50 for selectively blocking the signals transferred from the detector 12 to the controller 20, connected to the controller 20 or between the detector 12 and the controller 20, as shown in FIG. 31. This embodiment may also include a user command storage device 65 as shown in FIG. 32, which may store information on commands including a holding command and an activation command in correspondence with a digital signal received from the touch panel or detector controller 42. The user command information stored in the user command storage device 65 may include user commands for holding or activating only some functions, in addition to the holding command for holding all functions and the activation command for activating all functions.

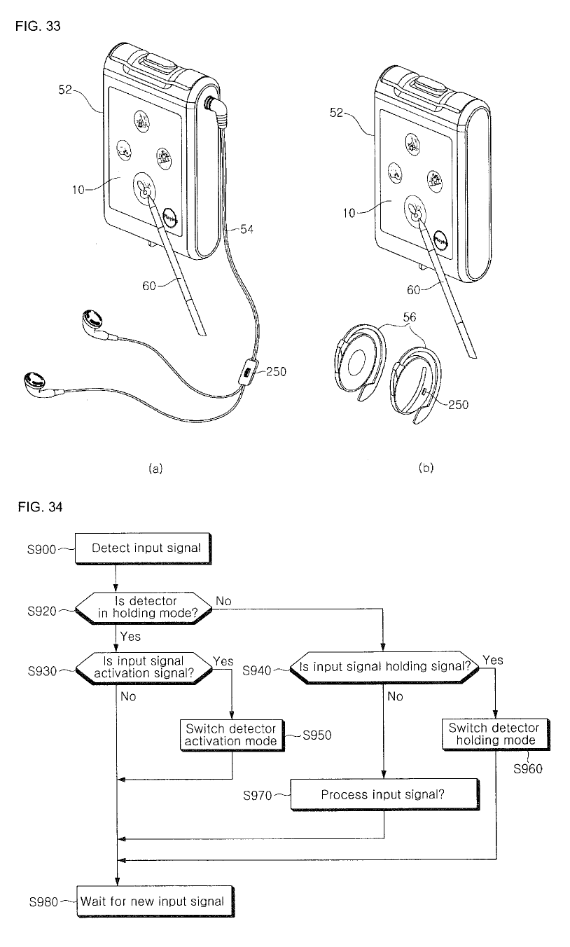

As shown in FIG. 33A, the switch 250 may be mounted on an earphone or earphone set 54 which may be connected to a main body 52 of the MP3 player according to one embodiment. The switch 250 may transmit an on/off signal for blocking or connecting the signals output by the detector 12 to the controller 20 through an output terminal (not shown) of the earphone or earphone set 54. Accordingly, the controller 20 may block or connect the signals output by the detector 12.

For example, whenever the switch 250 is pressed once, the signals of the detector 12 may be blocked or connected such that a holding mode and an activation mode are switched between each other. The holding mode may be a state in which, even though the detector 12 detects a touch, the controller 20 does not respond to the external touch. On the other hand, the activation mode may be a state in which the controller 20 responds to the touch detection by the detector 12. Therefore, the switch 250 may allow a mode of the MP3 player to be adjusted simply by manipulating the switch 250 mounted to the earphone or earphone set 54, when, for example, the MP3 player is stored in, for example, a pocket or bag.

Herein, various kinds of holding signals and activation signals may be employed when holding or activation commands are executed using the switch 250. The various kinds of holding signals and activation signals may include a partial holding signal for holding only some functions, a partial activation signal for activating only some functions, and the like. For example, embodiments may be configured in such a manner that only the other functions except a volume control function are held if the switch 250 is pressed twice.

As shown in FIG. 33B, according to another embodiment, the switch 250 may be mounted on a wireless earphone or earphone set 56 employing short range wireless communication. The switch 250 in FIG. 33B may also transmit an on/off signal for blocking or connecting the signals of the detector 12 to the controller 20 by transmitting a short range wireless signal. A wireless communication method, such as ZigBee™ or Bluetooth™ method, may be used for the short range wireless communication signals. The ZigBee™ method consumes less power and has a wider transmission range; however, the ZigBee™ method has a disadvantage that the amount of data transmittable is less than that of the Bluetooth™ method. However, the ZigBee™ method has an advantage that the amount of data of the on/off signal is much smaller than that of the Bluetooth™ method.

According to another embodiment, only a screen 10 and a controller 20 may be included. In this embodiment, the screen 10 may be configured such that the activation mode and the holding mode are switched between each other according to the input signals input into the detector 12.

That is, the controller 20 of this embodiment may cause the detector 12 to be switched to a holding mode when a holding signal is input into the detector 12 such that the input signals input into the detector 12 are not processed. Alternatively, the controller 20 may cause the detector 12 to be switched to an activation mode when an activation signal is input into the detector 12.

The activation signal may be a command that causes the detector 12 to be switched from the holding mode to the activation mode, whereas the holding signal may be a command that causes the detector 12 to be switched from the activation mode to the holding mode. The holding signal and the activation signal may be defined, stored, and changed by a user. For example, a diagonal line may be stored as a holding signal such that the diagonal line can be recognized as the holding signal when a user draws the diagonal line on the detector 12 using, for example, a stylus pen 60, as shown in FIG. 35A. Further, a circle may be stored as an activation signal such that the circle can be recognized as the activation signal when the user draws the circle on the detector 12, as shown in FIG. 35B.

Of course, a variety of touch types may be employed to correspond to the various kinds of holding signals and activation signals. That is, partial holding signals for holding only some functions and partial activation signals for activating only some functions may be stored according to a variety of touch types.

Operation of this embodiment may start by connecting the earphone or earphone set 54 to an MP3 player. A user may connect the earphone or earphone set 54 to the MP3 player, play back music, and put the MP3 player into, for example, a pocket, purse, or bag.

Then, the user may operate the switch 250 mounted to the earphone or earphone set 54 and cause the detector 12 to be switched to a holding mode. Since, in this embodiment, the detector 12 is switched to the holding mode, the detector 12 does not respond to the input signals input to the touch screen device. Thereafter, the user may cause the detector 12 to be switched to an activation mode using the switch 250, take the MP3 player out of the pocket, and input a new input signal to operate the MP3 player.

Another embodiment operates in a similar way as the above described embodiment, except that the on/off signals may be transmitted using the short range wireless communications.

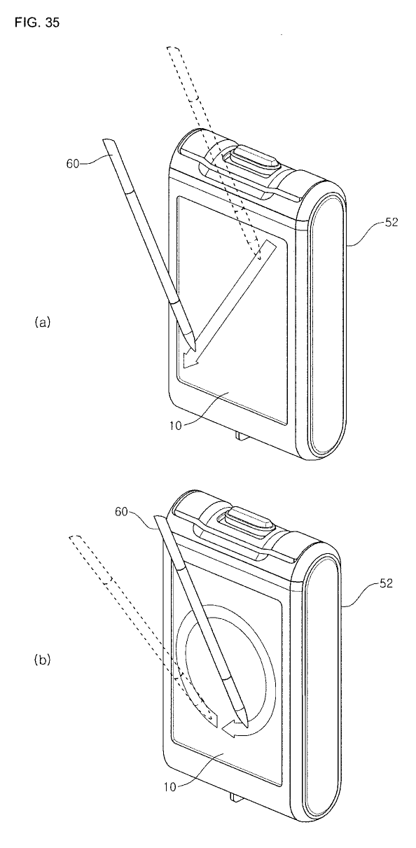

As shown in FIG. 34, a signal input into the detector 12 may be first detected, in step S900. Next, it may be checked whether the detector 12 is in a holding mode, in step S920. The holding mode may be a mode in which even though the signal is input into the detector 12, the controller 20 does not process the input signal. The reason is that an unintended command is not executed when the detector 12 is inadvertently pressed contrary to the intention of the user.

If the detector 12 is in a holding mode, it may be determined whether the input signal is an activation signal, in step S930. The determination whether the input signal is an activation signal may be made by comparing the input signal with the activation signal previously defined and stored by the user.

If it is determined that the input signal is an activation signal, the detector 12 may be switched to an activation mode and then stand by to receive a new input signal, in steps S950 and S980. If the input signal is not an activation signal, it may be a general signal other than the activation signal that is input in a state where the detector 12 is still in a holding mode. Thus, the detector 12 may not respond to the input signal and stand by to receive a new input signal, in step S980.

On the other hand, if the detector 12 is not in a holding mode, it may be determined whether the input signal is a holding signal, in step S940. In the same manner as the determination of whether the input signal is an activation signal, the determination whether the input signal is a holding signal may be made by comparing the input signal with the holding signal defined and stored by the user.

If the input signal is not a holding signal, the input signal may be processed, in step S950. However, if the input signal is a holding signal, the detector 30 may be switched to a holding mode, in step S960.

In alternate embodiments, the touch screen device may be activated by removing a stylus pen 60 from a housing (not shown) provided on the device. Further, the touch screen device may be de-activated by returning the stylus pen 60 to the housing.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of operating a touch screen device, comprising
detecting a touch, an initial touch point and a moving touch trajectory on a surface of a screen;
determining a command corresponding to the initial touch point and moving touch trajectory; and
executing the determined command when the touch is released.

2. A touch screen device, comprising:
a screen including a display that displays information thereon and a detector an initial touch point, a moving touch trajectory and a touch release point on the display; and
a controller that executes a command based on the detected initial touch point and moving touch trajectory.

3. A touch screen device, comprising:
a screen comprising a display that displays menu images thereon and a detector that detects a touch on the screen, wherein the detector is divided into an execution area and a selection area; and
a controller that controls the touch screen device based on the detected touch on the screen.

4. A method of operating a touch screen device, the method comprising:
detecting a touch on a screen;
executing a relevant menu placed on a touch point when the touch point is within an execution area of the screen; and
sequentially moving menu images placed on a selection area of the screen to the execution area when the touch point is within the selection area.

5. A method of selecting files on a touch screen, comprising:
detecting a touch drag on a screen;
detecting a list of items included within a range corresponding to a touch drag trajectory of the detected touch drag; and
marking the detected list for a subsequent execution action.

6. A touch screen device, comprising:
a screen including a display configured to display a list of items thereon and a detector configured to detect a touch on a screen; and
a controller configured to control operation of the device based on the touch on the screen detected by the detector, wherein, when a drag is detected on the screen, the controller is configured to skip items in the list included within a range corresponding to an associated drag trajectory and to execute items adjacent the skipped items.

7. A method of operating a touch screen device, the method comprising:
displaying a plurality of menus on a screen, each of the plurality of menus including a menu bar having an expanded portion at one end thereof, wherein each of the expanded portions are arranged in an alternating pattern on the screen.

8. A touch screen device, comprising:
a screen including a display that displays menu images thereon and a detector that detects a touch on the screen; and
a controller that displays two or more menu bars on the screen, the menu bars each having an expanded portion at one end portion thereof, wherein the two or more menu bars are displayed on the screen such that the expanded portions are arranged in an alternating pattern.

9. A method of displaying images on a touch screen device, the method comprising:
displaying two or more display windows on a screen in a partially overlapped manner; and
moving an underlying display window to an overlying position when a touch is detected on the underlying display window that is covered by an overlying display window.

10. A touch screen device, comprising:
a screen comprising a display that displays images thereon and a detector that detects a touch on the screen; and
a controller that displays two or more display windows on the screen in a partially overlapped manner, and moves an underlying display window to an overlying position when a touch is detected on the underlying display window covered by an overlying display window.

11. A touch screen device, comprising:
a screen comprising a display that displays images thereon and a detector that detects a touch and movement of the touch on the display; and
a controller configured that retrieves image information corresponding to the detected movement and displays an image on the screen.

12. A method of operating a touch screen device, the method comprising:
detecting a touch and a movement of the touch on a screen;
retrieving an image corresponding to the movement; and
displaying the retrieved image on the screen.

13. A touch screen device, comprising:
a screen comprising a display that displays images thereon and a detector that detects a touch on the screen;
a controller that controls operation of the touch screen device in accordance with the screen touch detected by the detector; and
a switch that selectively transmits a signal from the detector to the controller.

14. A touch screen device, comprising:
a screen comprising a display that displays images thereon and a detector that detects a touch on the screen; and
a controller that receives signals input from the detector when an activation signal is input to the controller, and that ignores input signals when a holding signal is input to the controller.
